(19) United States
(12) Patent Application Publication
(10) Pub. No.: US 2026/0083159 A1
(43) Pub. Date: Mar. 26, 2026

(54) SUGAR BEET PULP WITH IMPROVED WATER HOLDING CAPACITY

(71) Applicant: Coöperatie Koninklijke Cosun U.A., Breda (NL)

(72) Inventors: Edwin Gerhard Poiesz, Beltrum (NL); Robert Vreeker, Melissant (NL); Jan Marcel van der Vaart, Bergen op Zoom (NL)

(73) Assignee: Coöperatie Koninklijke Cosun U.A., Breda (NL)

(21) Appl. No.: 18/864,562

(22) PCT Filed: Nov. 29, 2022
(86) PCT No.: PCT/EP2022/083633

§ 371 Date: Nov. 11, 2024

(30) Foreign Application Priority Data
May 13, 2022 (EP) 22173214.2
May 13, 2022 (EP) 22173217.5

(51) Int. Cl. A23L 19/00; A23J 3/24; A23L 33/22; A23L 33/24

(52) U.S. Cl. CPC A23L 19/09; A23J 3/24; A23L 33/22; A23L 33/24

(57) ABSTRACT

The present invention concerns sugar beet pulp which is capable of absorbing and/or holding an amount of water that is at least 14 times the dry weight of the sugar beet pulp.

The present invention further concerns a method for improving the water absorption capacity and/or water holding capacity of sugar beet pulp, comprising the steps of:
(a) providing sugar beet material;
(b) optionally extracting mono- and disaccharides from the sugar beet material provided in step (a) at a temperature below 75° C. to provide spent sugar beet pulp;
(c) subjecting the sugar beet material provided in step (a) or the spent sugar beet pulp provided in step (b) to a heating step at a temperature of at least 85° C. to obtain sugar beet pulp with improved water absorption capacity and/or water holding capacity;
(d) optionally removing mono- and disaccharides from the sugar beet pulp obtained in step (c).

### FIELD OF THE INVENTION

The present invention concerns a method for treating sugar beet pulp to improve its water absorption capacity and/or water holding capacity and sugar beet pulp having improved water absorption capacity and/or water holding capacity. The present invention further concerns sugar beet pulp having improved water absorption capacity and/or water holding capacity obtained or obtainable by said method, food products comprising the sugar beet pulp and the use of the sugar beet pulp in or as a food product or as a carrier of further food-grade ingredients. Moreover, the present invention concerns a method for loading the sugar beet pulp with further food-grade ingredients, the products obtained therewith and food products consisting of or comprising the products obtained therewith. Furthermore, the invention concerns the use of the sugar beet pulp or of the sugar beet pulp loaded with further food-grade ingredients as a texturizer in food products, as a water retainer in food products, as a water absorber in food products and as a fat replacer in food products.

### BACKGROUND OF THE INVENTION

The production of sugar and related products (such as syrups, thick juices and molasses) from sugar beets conventionally comprises a number of process steps. In a first step, sugar beets are washed and sliced into so-called ‘cossettes’. The sugar beet cossettes are subjected to thermal cell disintegration and extraction in an extraction or diffusion apparatus. In said apparatus, sucrose along with other water-soluble ingredients are extracted from the thermally treated sugar beet cossettes by a warm aqueous diffusion process to obtain a so-called ‘raw juice’ or ‘diffusion juice’. Such techniques require prolonged exposure (typically between 30 and 180 minutes) of the sugar beet cossettes to elevated temperatures (typically 65-75° C.). This thermal treatment results in the denaturation of the cell membrane and partial disruption of the cell wall structure. Apart from the raw juice, the warm aqueous diffusion process results in a residue called (spent or exhausted) sugar beet pulp. This residue comprises the fibrous remainders of the sugar beet after the extraction of sucrose and other water-soluble ingredients.

Sugar beet pulp has not found many industrial applications, apart from its use as or in animal feed and in the production of biogas.

The world's increasing food consumption, particularly the increasing meat and fish consumption, goes hand in hand with long-term sustainability issues and puts increased pressure on scarce resources. Significant research efforts have thus been dedicated to developing new food products, particularly meat and fish substitutes or alternatives.

In this regard, it would be desirable if (bulky) side streams from industrial processes can be upgraded to food products or to ingredients for food products in an efficient way. Food or feed ingredients based on sugar beet pulp have already been proposed.

Unipektin AG offers Vidofibres® BF (April 2021), produced from 100% natural sugar beet pulp after sugar extraction from the plant species ‘Beta vulgaris’. The production encompasses subjecting spent sugar beet pulp to washing, pressing, drying, milling, sifting and standardization. The Vidofibres® BF would have a water binding capacity of up to 13.5 g water/1 g fibre, depending on quality. Vidofibres® BF is offered as a multifunctional dietary food ingredient that would provide dietary fibre content, moisture retention and texture to a variety of food products.

GB2439909A and GB23413073A disclose an un-molassed sugar beet pulp with a cell matrix which has been disrupted and/or adapted by a preconditioning process. The preconditioning process comprises steaming the sugar beet pulp at a temperature lower than 80° to allow ingress of water molecules thus rendering the sugar beet pulp moist, subsequently subjecting the moist pulp to infra-red radiation to effect a rapid heating of the moist pulp to substantially dry the same, and finally rolling said substantially dry pulp to produce flakes. This preconditioning process is intended to reduce rehydration/soaking time required before the product may be fed to ruminant and non-ruminant animals. The product brochure Speedi-Beet—Quick Soaking Beet Pulp Flakes for Horses & Ponies, from British Horse Feeds, accessible through www.britishhorsefeeds.com on Mar. 16, 2022, refers to GB2439909A and describes that the product holds 5 times its own weight of water for rapid rehydration.

It is an object of the invention to provide new food products and food ingredients based on sugar beets, particularly based on spent sugar beet pulp.

It is a further object of the invention to provide sugar beet pulp with improved water absorbing capacity and/or water holding capacity.

It is another object of the invention to provide a method for the preparation of sugar beet pulp with improved water absorption capacity and/or water holding capacity in an industrially feasible way.

It is yet another object of the invention to provide novel sugar-beet-based food products or sugar-beet-based food ingredients enriched in protein that can be used in or as meat and/or fish substitutes or alternatives or in hybrid meat and/or hybrid fish food products.

### SUMMARY OF THE INVENTION

The inventors have unexpectedly found that these objects can be met by subjecting sugar beet material to a step of heating at a temperature of at least 85° C. and preferably also to a step of freezing/thawing. Sugar beet material that was subjected to this treatment is able to absorb an amount of water and/or is able to hold an amount of water, that is at least 14 times its dry weight. The inventors have established that sugar beet pulp particles can be obtained having a relatively large median particle diameter and having at the same time high water holding capacity and/or water absorbing capacity.

Accordingly, in a first aspect, the invention provides sugar beet pulp which is capable of absorbing and/or holding an amount of water that is at least 14 times the dry weight of the sugar beet pulp.

In a second aspect, the invention provides a method for improving the water absorption capacity and/or water holding capacity of sugar beet pulp, comprising the steps of:
(a) providing sugar beet material;
(b) optionally extracting mono- and disaccharides from the sugar beet material provided in step (a) at a temperature below 75° C. to provide spent sugar beet pulp;
(c) subjecting the sugar beet material provided in step (a) or the spent sugar beet pulp provided in step (b) to heating at a temperature of at least 85° C. to obtain sugar beet pulp with an improved water absorption capacity and/or water holding capacity; and
(d) optionally removing mono- and disaccharides from the sugar beet pulp obtained in step (c).

In a third aspect, the invention provides sugar beet pulp capable of absorbing and/or holding an amount of water that is at least 14 times the dry weight of the sugar beet pulp, obtained or obtainable by the method according to the second aspect.

The inventors have unexpectedly found that sugar beet pulp according to the first or third aspect can due to its increased water absorption capacity and water holding capacity be effectively loaded with further food-grade ingredients, particularly with soluble protein, up to high loads, such as for example 70 wt. % protein on dry matter.

The invention therefore also provides, in a fourth aspect, a method for loading the sugar beet pulp according to the first or third aspect with further food-grade ingredients, said method comprising the steps of:
(i) providing the sugar beet pulp according to the first or third aspect;
(ii) providing further food-grade ingredients, preferably chosen from the group consisting of proteins, salts, flavourings, colourants and preservatives;
(iii) adding the further food-grade ingredients provided in step (ii) to the sugar beet pulp provided in step (i), preferably followed by mixing; and
(iv) contacting the sugar beet pulp and the further food-grade ingredients in the mixture provided in step (iii) to load the sugar beet pulp with further food-grade ingredients.

Moreover, the invention provides in a fifth aspect sugar beet pulp loaded with further food-grade ingredients, preferably loaded with protein, obtainable or obtained by the method of the fourth aspect.

A sixth aspect concerns a food product comprising the sugar beet pulp according to the first or third aspect, or comprising or consisting of the sugar beet pulp loaded with further food-grade ingredients according to the fifth aspect.

In a seventh aspect, the invention provides the use of the sugar beet pulp according to the first or the third aspect in a food product or as a carrier for further food-grade ingredients.

In an eighth aspect, the invention concerns the use of the sugar beet pulp according to the first or the third aspect or of the sugar beet pulp loaded with further food-grade ingredients according to the fifth aspect:
(a) as a texturizer in food products;
(b) as a water retainer in food products;
(c) as a water absorber in food products;
(d) as a fat replacer in food products; or
(e) a combination of two or more of (a)-(d).

### Definitions

The term ‘water holding capacity’ as used herein concerns the maximum amount of water in the sugar beet pulp according to the invention based on dry matter content of the sugar beet pulp, i.e. the maximum amount of water in the treated sugar beet pulp divided by the corresponding amount of dry matter of the treated sugar beet pulp. The ‘dry matter content’ of the sugar beet pulp is the part of the sugar beet pulp other than water.

The term ‘spent sugar beet pulp’ as used herein is considered interchangeable with ‘exhausted sugar beet pulp’ as used in the art. It concerns sugar beet material, typically in the form of cossettes, that has at least been subjected to sucrose extraction at a temperature of typically between 65 and 75° C. and a residence time of between 30 and 180 minutes.

The term ‘enriched in protein’ as used in the context of the present invention means that the sugar beet pulp that is loaded with protein has, after loading, a higher weight percentage of protein than before loading. The weight percentage of protein after loading is based on protein already present in and specific to the sugar beet pulp before loading and on protein loaded into the sugar beet pulp. Hence, the wording ‘loaded with protein’ and ‘enriched in protein’ in the context of the present invention are considered interchangeable.

The term ‘soluble proteins’ as used herein refers to proteins that (still) have a high level of aqueous solubility. The term ‘soluble proteins’ as used herein is considered similar to the terms ‘techno-functional proteins’, ‘(substantially) native proteins’ and ‘(substantially) undenatured proteins’ as used in the art. In the context of the present invention, protein is considered soluble if it has an aqueous solubility at pH=7.0 and T=20° C. of at least 20%, preferably at least 50%, more preferably at least 70%, as measured in accordance with the analytical protocol defined in the experimental section. Some proteins have a very limited solubility at pH=7.0 and T=20° C. but do have a considerable solubility at pH=3.0 and T=20° C. In the context of the present invention, protein is also considered soluble if it has an aqueous solubility at pH=3.0 and T=20° C. of at least 20%, preferably at least 50%, more preferably at least 70%, as measured in accordance with the analytical protocol defined in the experimental section.

The term ‘immobilization’ as used herein refers to a step wherein the soluble, i.e. mobile, protein is treated with for example heat, a change in pH, a change in pH to the isoelectric point or a combination thereof, to cause precipitation, denaturation and/or coagulation of the protein.

The term ‘denaturation’ refers to the loss of native conformation and biological activity of the protein. Denatured proteins decrease in aqueous solubility and may therefore precipitate from an aqueous solution. Denaturation can be induced using physical measures, such as heating or repeated freezing and thawing, or using chemical agents, such as strong acids or bases, i.e. extreme pH conditions. Depending on the conditions, the denaturation and the corresponding decrease in aqueous solubility may be reversible or irreversible.

Denaturation is the first step of coagulation. The term ‘coagulation’ refers to the solidification change of proteins, i.e. the formation of insoluble aggregates, caused by physical and/or chemical factors, resulting in denaturation and precipitation. Again, depending on the conditions, the coagulation may be reversible or irreversible.

The term ‘precipitation’ as used herein concerns the process by which the protein separates out from an aqueous solution. Apart from precipitation due to denaturation as described supra, protein can typically also be precipitated by removal of the electrostatic repulsion and the hydration shell. Examples are precipitation of the protein at the isoelectric point, also called ‘flocculation’, by adjusting the pH. Flocculation typically is a reversible process. Flocculated protein can, however, be subsequently treated with heat to irreversibly deteriorate the techno-functional properties of the protein, such as its aqueous solubility. Precipitation by dehydration can for example be induced using an alcohol. Moreover, precipitation of proteins can be induced using certain salts.

The term ‘food-grade ingredients’ as used herein concerns ingredients that are non-toxic to humans and are safe for consumption.

The term ‘hybrid meat and or hybrid fish food products’ as used herein concerns food products comprising meat or fish and further comprising plant-based ingredients such as vegetables, plant proteins, mushrooms or seeds.

The term ‘comprise’ and ‘include’ as used throughout the specification and the accompanying items/claims as well as variations such as ‘comprises’, ‘comprising’, ‘includes’ and ‘including’ are to be interpreted inclusively. These words are intended to convey the possible inclusion of other elements or integers not specifically recited, where the context allows, unless specified otherwise.

The articles ‘a’ and ‘an’ are used herein to refer to one or to more than one (i.e. to one or at least one) of the grammatical object of the article. By way of example, ‘an element’ may mean one element or more than one element, unless specified otherwise.

### BRIEF DESCRIPTION OF THE FIGURES

FIG. 1a depicts the experimental setup for measuring the average firmness (or hardness or toughness) of a sample of sugar beet material. FIG. 1b depicts the positioning of the sample in the experimental setup of FIG. 1a.

FIG. 2a depicts images made by confocal scanning laser microscopy of the sugar beet pulp loaded with whey protein in Example 4 using wet protein loading followed by immobilization using thermal coagulation. FIG. 2b is a copy of FIG. 2a wherein the colours have been slightly changed to highlight the immobilized whey protein in the matrix of the sugar beet pulp. The white areas in FIG. 2b correspond to whey protein, the grey areas to the matrix of the sugar beet pulp and the black areas to the background.

FIG. 3a depicts images made by confocal scanning laser microscopy of the sugar beet pulp loaded with whey protein in Example 4 using dry protein loading followed by immobilization using thermal coagulation. FIG. 3b is a copy of FIG. 3a wherein the colours have been slightly changed to highlight the immobilized whey protein in the matrix of the sugar beet pulp. The white areas in FIG. 3b correspond to whey protein, the grey areas to the matrix of the sugar beet pulp and the black areas to the background.

### DETAILED DESCRIPTION

### Sugar Beet Pulp

A first aspect of the invention concerns sugar beet pulp which is capable of absorbing and/or holding an amount of water that is at least 14 times the dry weight of the sugar beet pulp.

The first aspect covers sugar beet pulp with improved water absorption capacity and/or water holding capacity, irrespective of whether the maximum water holding capacity of the sugar beet pulp is actually realized. As will be appreciated by those skilled in the art, the sugar beet pulp can only absorb water if it is not already fully hydrated. Sugar beet pulp according to the first aspect that has a water content of about 97 wt. % is fully hydrated and has already absorbed the maximum amount of water. Sugar beet pulp according to the first aspect can only absorb water unto full hydration if dried first and then rehydrated.

As will be appreciated by those skilled in the art, the wording ‘capable of holding an amount of water that is at least . . . ’ is synonymous to ‘having a water holding capacity of at least . . . ’. Likewise, the wording ‘capable of absorbing an amount of water of at least . . . ’ is synonymous to ‘having a water absorption capacity of at least . . . ’. The water absorption capacity and water holding capacity are to be determined using the analytical protocols defined in the experimental section.

In preferred embodiments, the sugar beet pulp is capable of absorbing and/or holding an amount of water that is at least 15, 16, 17, 18, 19, 20, 21, 22, 23, 24, 25, 26, 27, 28, 29 or 30 times the dry weight of the sugar beet pulp.

In embodiments, the sugar beet pulp is capable of absorbing and/or holding an amount of water that is between 14 and 33 times the dry weight of the sugar beet pulp, such as between 14 and 28, between 14 and 26, between 14 and 24, between 14 and 22 or between 14 and 20 times the dry weight of the sugar beet pulp.

In other embodiments, the sugar beet pulp is capable of absorbing and/or holding an amount of water that is between 15 and 33 times the dry weight of the sugar beet pulp, such as between 17 and 33, between 19 and 33, between 20 and 33, between 21 and 33 or between 22 and 33 times the dry weight of the sugar beet pulp.

In preferred embodiments, the sugar beet pulp according to the first aspect has a water content of between 3 and 97 wt. %, based on the weight of the sugar beet pulp.

In another preferred embodiment, the sugar beet pulp according to the first aspect has a water content of between 3 and 20 wt. %, based on the weight of the sugar beet pulp, more preferably between 4 and 18 wt. %, even more preferably between 5 and 10 wt. %, such as 7 wt. %.

In a very preferred embodiment, the sugar beet pulp according to the first aspect has a water content of between 60 and 97 wt. %, based on the weight of the sugar beet pulp, more preferably a water content of between 70 and 97 wt. %, such as between 75 and 97 wt. %, between 78 and 97 wt. %, between 80 and 97 wt. %, between 82 and 97 wt. %, between 85 and 97 wt. %, between 88 and 97 wt. % or between 90 and 97 wt. %.

In another preferred embodiment, the sugar beet pulp according to the first aspect has a water activity (AW) between 0.10 and 0.80, more preferably between 0.20 and 0.76, even more preferably between 0.30 and 0.60, as measured at 25° C. with a Lab Master-aw neo water activity measurement device (Novasina AG).

In a preferred embodiment, the sugar beet pulp according to the first aspect comprises at least 20 wt. % pectin, based on dry matter of the sugar beet pulp, more preferably at least 21 wt. %, such as at least 22 wt. %, at least 23 wt. % or at least 24 wt. %.

As will be appreciated by the skilled person, the sugar beet pulp according to the first aspect has a certain particle size (distribution). The average size or average largest dimension of the particles of the sugar beet pulp according to the first aspect is not particularly limited. However, as will be appreciated by those skilled in the art, the higher the specific surface area (surface area divided by volume) of the particles of the sugar beet pulp, the higher the de- and/or rehydration speed. Accordingly, in a preferred embodiment, the spent sugar beet pulp according to the first aspect has a particle size or largest dimension between 0.5 mm and 5 cm, more preferably between 1 mm and 1 cm.

In a preferred embodiment, the sugar beet pulp according to the first aspect in fully hydrated form has a median particle diameter of between 500 μm and 10 mm, as determined using wet sieving, preferably a median particle diameter of between 700 μm and 5 mm, more preferably a median particle diameter of between 850 μm and 2 mm, such as between 900 μm and 1.6 mm. The analytical protocol for determining this median particle diameter is defined in the experimental section.

Sugar beet pulp according to the first aspect having in fully hydrated form a median particle diameter of between 500 μm and 10 mm, as determined using wet sieving, is preferably applied in meat substitutes or alternatives, fish substitutes or alternatives, hybrid meat and/or hybrid fish food products, soups, dressings, fruit preparations, breakfast cereals, cereal bars, bakery products, snacks and salads.

In another embodiment, the sugar beet pulp according to the first aspect in fully hydrated form has a median particle diameter (D50) of between 100 and 850 μm, as determined using liquid dispersion laser diffraction, preferably a median particle diameter (D50) of between 150 and 650 μm, more preferably a median particle diameter (D50) of between 200 and 500 μm. The analytical protocol for determining this median particle diameter (D50) is defined in the experimental section.

Mouthfeel of liquid or viscous food products typically requires a smaller particle size. Sugar beet pulp according to the first aspect having in fully hydrated form a median particle diameter (D50) of between 100 and 850 μm, as determined using liquid dispersion laser diffraction, is preferably applied in soups, dressings, sauces, dairy products and salads.

In an embodiment, the sugar beet pulp according to the first aspect in fully hydrated form has a median particle diameter (D50) of between 250 and 550 μm, a D10 value between 40 and 200 μm and a D90 value between 600 and 1500 μm, as determined using liquid dispersion laser diffraction, preferably a median particle diameter (D50) of between 350 and 500 μm, a D10 value between 80 and 150 μm and a D90 value between 950 and 1300 μm.

In a very preferred embodiment, the sugar beet pulp according to the first aspect is processed spent sugar beet pulp, i.e. spent sugar beet pulp that has been treated to improve its water absorption capacity and/or water holding capacity.

In an embodiment, the sugar beet pulp according to the first aspect comprises cellulose and hemicellulose.

In a preferred embodiment, the sugar beet pulp according to the first aspect comprises, based on dry weight of the sugar beet pulp, less than 6 wt. % of mono- and disaccharides, such as less than 5 wt. %, less than 4 wt. %, less than 3 wt. %, less than 2.5 wt. %, less than 2 wt. %, less than 1.5 wt. %, less than 1 wt. % or less than 0.5 wt. %.

As will be appreciated by those skilled in the art, the wording ‘less than x wt. % of mono- and disaccharides’ concerns a maximum wt. % of the combined amounts of the mono- and disaccharides.

In a very preferred embodiment, the mono- and disaccharides are chosen from the group consisting of glucose, sucrose and fructose.

In a preferred embodiment, the sugar beet pulp according to the first aspect is food grade. The term ‘food grade’ as used herein means that the sugar beet pulp according to the first aspect is suitable for human consumption. Food-grade products generally require low microbial counts per gram product. Processed sugar beet material may contain high numbers of microorganisms per gram.

In a preferred embodiment, the sugar beet pulp according to the first aspect has one or more, preferably all, of the following microbial requirements:
total thermophilic bacteria count: ≤1000 CFU/(g of the sugar beet pulp), as determined in accordance with ISO 4833-1:2013;
total thermophilic spores count: ≤25 CFU/(g of the sugar beet pulp), as determined in accordance with ICUMSA GS2_{/3}-49 (1998);
total mesophilic bacteria count: ≤150 CFU/(g of the sugar beet pulp), as determined in accordance with ISO 4833-1:2013;
total mesophilic spores count: ≤150 CFU/(g of the sugar beet pulp), as determined in accordance with NEN 6813:2014 nl;
total moulds count: ≤1 CFU/(g of the sugar beet pulp), as determined in accordance with ISO 21527-1:2008; and
total yeast count: ≤1 CFU/(g of the sugar beet pulp), as determined in accordance with ISO 21527-1:2008.

In a preferred embodiment, the sugar beet pulp according to the first aspect has one or more, preferably all, of the following microbial requirements:
total thermophilic bacteria count: ≤500 CFU/(g of the sugar beet pulp), more preferably ≤100 CFU/(g of the sugar beet pulp), even more preferably ≤10 CFU/(g of the sugar beet pulp), yet more preferably ≤1 CFU/(g of the sugar beet pulp), as determined in accordance with ISO 4833-1:2013;
total thermophilic spores count: ≤20 CFU/(g of the sugar beet pulp), more preferably ≤10 CFU/(g of the sugar beet pulp), even more preferably ≤5 CFU/(g of the sugar beet pulp), yet more preferably ≤1 CFU/(g of the sugar beet pulp), as determined in accordance with ICUMSA GS2 3-49 (1998);
total mesophilic bacteria count: ≤50 CFU/(g of the sugar beet pulp), more preferably ≤10 CFU/(g of the sugar beet pulp), even more preferably ≤5 CFU/(g of the sugar beet pulp), yet more preferably ≤1 CFU/(g of the sugar beet pulp), as determined in accordance with ISO 4833-1:2013;
total mesophilic spores count: ≤50 CFU/(g of the sugar beet pulp), more preferably ≤10 CFU/(g of the sugar beet pulp), even more preferably ≤5 CFU/(g of the sugar beet pulp), yet more preferably ≤1 CFU/(g of the sugar beet pulp), as determined in accordance with NEN 6813:2014 nl;
total moulds count: ≤1 CFU/(g of the sugar beet pulp), as determined in accordance with ISO 21527-1:2008; and
total yeast count: ≤1 CFU/(g of the sugar beet pulp), as determined in accordance with ISO 21527-1:2008.

In a preferred embodiment, the sugar beet pulp according to the first aspect has one or more, preferably all, of the following microbial requirements:
Salmonella spp: non-detectable number of CFU/(25 g of the sugar beet pulp), as determined in accordance with ISO 6579-1:2017;
Enterobacteriaceae: non-detectable number of CFU/(25 g of the sugar beet pulp), as determined in accordance with ISO 21528-1:2017;
Staphylococcus aureus: non-detectable number of CFU/(g of the sugar beet pulp), as determined in accordance with ISO-6888-3:2003;
Listeria spp: non-detectable number of CFU/(25 g of the sugar beet pulp), as determined in accordance with NEN-EN-ISO 11290-1/2:2014;
Listeria monocytogenes: non-detectable number of CFU/(25 g of the sugar beet pulp), as determined in accordance with NEN-EN-ISO 11290-1/2:2014; and
B. cereus: ≤100 CFU/(g of the sugar beet pulp), preferably ≤50 CFU/(g of the sugar beet pulp), as determined in accordance with ISO 7932:2004.

Soil, sand and clay particles typically stick to sugar beets that are delivered to a sugar factory. Typically, sugar beets are thoroughly washed prior to slicing the beets into cossettes and subjecting the cossettes to extraction in a diffusion tower. Although the washing process is very intense, there still remain soil, sand and clay particles on the cossettes. Food-grade sugar beet pulp preferably has a very low content of soil, sand and clay particles, since the presence of these particles may result in a negative consumer experience in the mouth.

In a preferred embodiment, the sugar beet pulp according to the first aspect comprises less than 8 wt. % of HCl-unsolvable ash, based on the dry weight of the sugar beet pulp, as measured in accordance with NEN-ISO 5985:2003, more preferably less than 6 wt. %, even more preferably less than 4 wt. %, such as less than 3 wt. %, less than 2 wt. %, less than 1.8 wt. %, less than 1.5 wt. %, less than 1.4 wt. %, less than 1.3 wt. %, less than 1.2 wt. % or less than 1.1 wt. %.

Without wishing to be bound by any particular theory, it is believed that the sugar beet particles according to the first aspect, particularly the sugar beet particles having a median particle diameter of between 500 μm and 10 mm as determined using wet sieving, essentially consist of fragments comprising clusters of collapsed/ruptured parenchymal cells, wherein the cell wall structures are largely or completely intact, i.e. at the primary, secondary and tertiary level. It is believed that this intact cell wall structure is responsible for advantageous organoleptic properties of the sugar beet particles, such as a juicy character.

The inventors have found that sugar beet pulp having a specific firmness, toughness or hardness results in advantageous organoleptic properties, particularly if the sugar beet pulp is applied in food products, such as food products selected from the group consisting of meat substitutes or alternatives, fish substitutes or alternatives, hybrid meat and/or hybrid fish food products, fruit preparations, breakfast cereals, cereal bars, bakery products, pastry, snacks and salads. As used herein, the term ‘firmness’ in the context of the sugar beet pulp according to the first aspect is considered synonymous to ‘hardness’ and ‘toughness’. If the sugar beet pulp is too firm, tough or hard, the food product has un unacceptable bite. If the sugar beet pulp is not firm, tough or hard enough, the structural integrity of the pulp may be completely lost.

In a preferred embodiment, the average firmness of the sugar beet pulp according to the first aspect at a temperature of 20° C. is between 100 and 900 g, as measured with a texture analyzer (Stable Micro Systems Ltd, TA-XT Plus) equipped with a 5 kg load cell, a slotted base plate and a standard knife/blade set (HDP/BS) consisting of a reversible knife edge and a Warner Bratzler blade, in accordance with the analytical procedure defined in the experimental section, more preferably between 150 and 800 g, even more preferably between 200 and 700 g, still more preferably between 250 and 600 g, such as between 300 and 550 g or between 350 and 500 g.

The inventors have further found that sugar beet pulp having a specific repeated water desorption-absorption power results in advantageous organoleptic properties, such as juiciness, particularly if the sugar beet pulp is applied in food products, such as food products selected from the group consisting of meat substitutes or alternatives, fish substitutes or alternatives, hybrid meat and/or hybrid fish food products, fruit preparations, breakfast cereals, cereal bars, bakery products, pastry, snacks and salads. As used herein, the term ‘repeated water desorption-absorption power’ relates to the amount of water the sugar beet pulp according to the first aspect can hold and absorb after pressing to reduce the water content and rehydrating the sugar beet pulp several times. The repeated water desorption-absorption power is measured in accordance with the analytical protocol defined in the experimental section.

Method for Improving the Water Absorption Capacity and/or Water Holding Capacity of Sugar Beet Pulp

In a second aspect, the invention concerns a method for improving the water absorption capacity and/or water holding capacity of sugar beet pulp, comprising the steps of:
(a) providing sugar beet material;
(b) optionally extracting mono- and disaccharides from the sugar beet material provided in step (a) at a temperature below 75° C. to provide spent sugar beet pulp;
(c) subjecting the sugar beet material provided in step (a) or the spent sugar beet pulp provided in step (b) to heating at a temperature of at least 85° C. to obtain sugar beet pulp with an improved water absorption capacity and/or water holding capacity; and
(d) optionally removing mono- and disaccharides from the sugar beet pulp obtained in step (c).

In a preferred embodiment of the second aspect, the method for improving the water absorption capacity and/or water holding capacity of sugar beet pulp, comprises the steps of:
(a) providing sugar beet material comprising more than 6 wt. % of mono- and disaccharides, based on dry weight of the sugar beet material;
(b) optionally extracting mono- and disaccharides from the sugar beet material provided in step (a) at a temperature below 75° C. to provide spent sugar beet pulp;
(c) subjecting the sugar beet material provided in step (a) or the spent sugar beet pulp provided in step (b) to heating at a temperature of at least 85° C. to obtain sugar beet pulp with an improved water absorption capacity and/or water holding capacity; and
(d) optionally removing mono- and disaccharides from the sugar beet pulp obtained in step (c);
   wherein the sugar beet pulp obtained in step (c) or (d) comprises, based on dry weight of the sugar beet pulp, less than 6 wt. % of mono- and disaccharides.

In an embodiment, the sugar beet material provided in step (a) comprises, based on dry weight of the sugar beet material, more than 7 wt. % of mono- and disaccharides, such as more than 8 wt. %, more than 10 wt. %, more than 12 wt. %, more than 15 wt. %, more than 20 wt. % or more than 25 wt. %.

As will be appreciated by those skilled in the art, the wording ‘more than x wt. % of mono- and disaccharides’ concerns a minimum wt. % of the combined amounts of the mono- and disaccharides.

In an embodiment, the sugar beet pulp obtained in step (c) or (d) comprises, based on dry weight of the sugar beet pulp, less than 5 wt. % of mono- and disaccharides, such as less than 4 wt. %, less than 3 wt. %, less than 2.5 wt. %, less than 2 wt. %, less than 1.5 wt. %, less than 1 wt. % or less than 0.5 wt. %

As will be appreciated by those skilled in the art, the wording ‘less than x wt. % of mono- and disaccharides’ concerns a maximum wt. % of the combined amounts of the mono- and disaccharides.

In an embodiment, the sugar beet material provided in step (a) comprises fresh sugar beets, preferably fresh sugar beets in particulate form such as sugar beet cossettes. Fresh sugar beets typically comprise more than 50 wt. % of mono- and disaccharides, based on dry weight of the sugar beets, such as about 75 wt. %. If step (b) is not mandatory, the method of the second aspect preferably comprises step (d) of removing mono- and disaccharides from the sugar beet pulp obtained in step (c).

In a preferred embodiment, the process according to the second aspect comprises one or more steps of washing the sugar beet material provided in step (a) and/or the spent sugar beet pulp provided in step (b) and/or the sugar beet pulp with improved water absorption capacity and/or water holding capacity provided in step (c), to remove soil, clay and/or sand particles.

In a preferred embodiment, the sugar beet material provided in step (a) comprises fresh sugar beets and step (b) is mandatory to provide spent sugar beet pulp. Spent sugar beet pulp is particulate sugar beet pulp, typically in the form of cossettes, that has been subjected to sucrose extraction in a diffusion tower at a temperature of typically between 65 and 75° C. at a residence time of between 30 and 180 minutes. Spent sugar beet pulp may have been pressed to reduce its water content.

In a preferred embodiment, step (c) of the second aspect comprises subjecting the sugar beet material provided in step (a) or the spent sugar beet pulp provided in step (b) to heating at a temperature of at least 90° C., more preferably at a temperature of at least 95° C., even more preferably at a temperature of at least 100° C.

In an embodiment, heating step (c) is performed for a period of at least 1 minute, such as at least 5 minutes, at least 10 minutes, at least 15 minutes, at least 20 minutes, at least 30 minutes, at least 40 minutes, at least 50 minutes, at least 80 minutes or at least 120 minutes.

In a preferred embodiment, heating step (c) is performed for a period of between 1 and 60 minutes, between 2 and 60 minutes, between 5 and 60 minutes, between 10 and 60 minutes, between 15 and 60 minutes, between 20 and 60 minutes, between 30 and 60 minutes or between 40 and 60 minutes.

In another preferred embodiment, heating step (c) is performed for a period of between 1 and 55 minutes, between 2 and 50 minutes, between 5 and 45 minutes, between 10 and 40 minutes, between 15 and 30 minutes, between 17 and 25 minutes or between 18 and 23 minutes.

In a preferred embodiment, step (c) of the second aspect comprises subjecting the sugar beet material provided in step (a) or the spent sugar beet pulp provided in step (b) to heating at a temperature of at least 85° C., for a period of between 1 and 120 minutes, between 5 and 100 minutes, between 8 and 90 minutes, between 10 and 80 minutes, between 15 and 75 minutes, between 20 and 70 minutes, between 30 and 65 minutes or between 40 and 60 minutes.

In another preferred embodiment, step (c) of the second aspect comprises subjecting the sugar beet material provided in step (a) or the spent sugar beet pulp provided in step (b) to heating at a temperature of at least 90° C., for a period of between 10 and 60 minutes, between 15 and 50 minutes, between 17 and 40 minutes or between 18 and 30 minutes.

In yet another preferred embodiment, step (c) of the second aspect comprises subjecting the sugar beet material provided in step (a) or the spent sugar beet pulp provided in step (b) to heating at a temperature of at least 95° C., for a period of between 15 and 30 minutes, between 17 and 25 minutes or between 18 and 23 minutes.

As will be appreciated by the skilled person, step (c) can also be performed at superheated conditions, i.e. at increased pressure. In a preferred embodiment, step (c) of the second aspect comprises subjecting the sugar beet material provided in step (a) or the spent sugar beet pulp provided in step (b) to heating at a temperature of between 85 and 120° C., more preferably at a temperature of between 9° and 115° C., even more preferably at a temperature of between 95 and 110° C.

Most preferably, step (c) of the second aspect comprises subjecting the sugar beet material provided in step (a) or the spent sugar beet pulp provided in step (b) to heating at a temperature of about 100° C. at atmospheric pressure.

In a preferred embodiment, step (c) is performed in an excess amount of water. The term ‘excess of amount of water’ as used here means that the amount of water is higher than the amount that can be absorbed by the sugar beet material provided in step (a) or the spent sugar beet pulp provided in step (b), meaning that, after heating step (c), the sugar beet material or sugar beet pulp will be further hydrated. After a sufficient period of time, the sugar beet material or sugar beet pulp will be fully hydrated.

The inventors have found that step (c) considerably increases the water absorption capacity and water holding capacity of the sugar beet pulp. It was further found that additional process steps, particularly freezing and thawing, further increase the water absorption capacity and water holding capacity of the sugar beet pulp.

In a preferred embodiment, the method of the second aspect further comprises one or more steps chosen from:
pulsed electric field treatment;
cutting, slicing or milling;
removing water by sieving, pressing, drying or a combination thereof;
freezing and thawing; and
sieving.

In a preferred embodiment, the method of the second aspect further comprises:
freezing and thawing;
optionally cutting, slicing or milling;
optionally pressing; and
optionally removing water by sieving, pressing, drying or a combination thereof.

In a preferred embodiment, the method of the second aspect further comprises freezing and thawing.

Any individual process step defined in the context of the second aspect may be applied one or multiple times to further increase the water holding capacity and/or water absorption capacity. Overtreatment of the sugar beet pulp is however to be avoided because the pulp should not lose its structural integrity. It is within the skills of the artisan to choose appropriate process conditions. The order of the steps is not particularly limited. Freezing/thawing can for example be performed before heating step (c) of after heating step (c).

In a very preferred embodiment, the sugar beet material provided in step (a) or the spent sugar beet pulp provided in step (b) is heated in step (c) at a temperature of at least 85° C., preferably at a temperature of at least 90° C., more preferably at a temperature of at least 95° C., even more preferably at a temperature of at least 100° C., and subjected to the following steps, preferably also in the following order:
freezing and thawing;
optionally cutting, slicing or milling;
additional heating at a temperature of at least 85° C., preferably at a temperature of at least 90° C., more preferably at a temperature of at least 95° C., even more preferably at a temperature of at least 100° C.; and
optionally removing water by sieving, pressing, drying or a combination thereof.

An embodiment of the second aspect concerns a method for improving the water absorption capacity and/or water holding capacity of sugar beet pulp, comprising the steps of:
(a) providing fresh sugar beets, preferably in the form of cossettes;
(b) subjecting the fresh sugar beets provided in step (a) to heating at a temperature of at least 85° C., preferably at a temperature of at least 90° C., more preferably at a temperature of at least 95° C., even more preferably at a temperature of at least 100° C., to obtain sugar beet pulp with improved water absorption capacity and/or water holding capacity;
(c) removing mono- and disaccharides from the sugar beet pulp obtained in step (b);
   wherein the sugar beet pulp obtained in step (c) comprises, based on dry weight of the sugar beet pulp, less than 6 wt. % of mono- and disaccharides, and
   wherein the process further comprises the following steps, preferably also in the following order:
freezing and thawing;
optionally cutting, slicing or milling;
additional heating at a temperature of at least 85° C., preferably at a temperature of at least 90° C., more preferably at a temperature of at least 95° C., even more preferably at a temperature of at least 100° C.; and
optionally removing water by sieving, pressing, drying or a combination thereof.

A very preferred embodiment of the second aspect concerns a method for improving the water absorption capacity and/or water holding capacity of sugar beet pulp, comprising the steps of:
(aa) providing fresh sugar beets, preferably in the form of cossettes;
(bb) extracting mono- and disaccharides from the sugar beet material provided in step (aa) at a temperature below 75° C. to provide spent sugar beet pulp;
(cc) subjecting the spent sugar beet pulp obtained in step (bb) to heating at a temperature of at least 90° C. for at least 10 minutes;
(dd) freezing the sugar beet pulp obtained in step (cc);
(ee) optionally reducing the particle size of the sugar beet pulp obtained in step (dd), preferably by cutting slicing or milling;
(ff) thawing the sugar beet pulp obtained in step (dd) or (ee), to obtain sugar beet pulp with an improved water absorption capacity and/or water holding capacity; and
(gg) optionally reducing the particle size of the sugar beet pulp obtained in step (ff), preferably by cutting slicing or milling.

A very preferred embodiment of the second aspect concerns a method for improving the water absorption capacity and/or water holding capacity of sugar beet pulp, comprising the steps of:
(a) providing fresh sugar beets, preferably in the form of cossettes;
(b) extracting mono- and disaccharides from the sugar beet material provided in step (a) at a temperature below 75° C. to provide spent sugar beet pulp;
(c) subjecting the spent sugar beet pulp provided in step (b) to heating at a temperature of at least 85° C., preferably at a temperature of at least 90° C., more preferably at a temperature of at least 95° C., even more preferably at a temperature of at least 100° C., to obtain sugar beet pulp with improved water absorption capacity and/or water holding capacity;
(d) optionally removing mono- and disaccharides from the sugar beet pulp obtained in step (c);
   wherein the sugar beet pulp obtained in step (c) or (d) comprises, based on dry weight of the sugar beet pulp, less than 6 wt. % of mono- and disaccharides, and wherein the process further comprises the following steps, preferably also in the following order:
freezing and thawing;
optionally cutting, slicing or milling;
additional heating at a temperature of at least 85° C., preferably a temperature of at least 90° C., more preferably a temperature of at least 95° C., even more preferably a temperature of at least 100° C.; and
optionally removing water by sieving, pressing, drying or a combination thereof.

Whether any or all steps of removing water by sieving, pressing, drying or a combination thereof are performed or not depends on the further application of the thus processed sugar beet pulp. If the intermediate product of the thus processed sugar beet pulp is for example without delay further processed, for example by loading the sugar beet pulp with further food-grade ingredients, preferably with soluble protein, typically only sieving and/or pressing is performed to slightly reduce the water content. If the thus processed spent sugar beet pulp is considered a final product or an intermediate product that is only further processed after some time, further drying may be required to avoid microbial spoilage and preserve shelf-life.

In an embodiment, the process according to the second aspect comprises a drying step, e.g. freeze drying or drying in a hot air oven, to obtain a product having a water activity (AW) between 0.10 and 0.80, more preferably between 0.20 and 0.76, even more preferably between 0.30 and 0.60, as measured at 25° C. with a Lab Master-aw neo water activity measurement device (Novasina AG).

The inventors have established that the water holding capacity of sugar beet particles, particularly when the median particle size of the sugar beet particles is in the order of a mm or larger, is negatively affected by a drying step.

In a very preferred embodiment, the moisture content of the sugar beet material and sugar beet pulp is higher than 60 wt. %, based on the weight of the sugar beet material or the sugar beet pulp, during the process according to the second aspect, preferably higher than 70 wt. %, higher than 75 wt. %, higher than 78 wt. % or higher than 80 wt. %.

Without wishing to be bound by any theory, the inventors believe that organic solvent extraction, acid treatment and alkali treatment reduce the pectin content in the sugar beet material.

In a preferred embodiment, the process according to the second aspect does not comprise the steps of:
(i) organic solvent treatment or extraction;
(ii) treatment with sulphited water;
(iii) potassium oxalate treatment or extraction;
(iv) sulphurous acid treatment or extraction;
(v) hydrogen peroxide treatment;
(vi) acid treatment;
(vii) alkali treatment; or
(viii) a combination of two or more of (i)-(vii).

Non-limiting examples of organic solvents used in organic solvent treatment or extraction are isopropyl alcohol (IPA) and ethanol.

In a very preferred embodiment, the process according to the second aspect does not comprise a step wherein one or more chemicals are added. As will be appreciated by those skilled in the art, distilled, potable or tap water is not considered a ‘chemical’ in this context.

In a very preferred embodiment, the process according to the second aspect does not apply a step of high-shear mixing affecting the sugar beet pulp's primary, secondary and/or tertiary structures characteristic of parenchymal cell wall material.

In a very preferred embodiment, the method according to the second aspect is for the manufacture of the sugar beet pulp according to the first aspect.

In a preferred embodiment, the sugar beet pulp with improved water absorption capacity and/or water holding capacity produced using the process according to the second aspect is characterized by one or more of the following:
the sugar beet pulp is food grade;
the sugar beet pulp comprises less than 8 wt. % of HCl-unsolvable ash, as defined in the context of the first aspect;
the sugar beet pulp has the microbial requirements as defined in the context of the first aspect;
the average firmness of the sugar beet pulp is as defined in the context of the first aspect;
the amount of water is between 3 and 97 wt. %, based on the weight of the sugar beet pulp; and
the sugar beet pulp comprises cellulose and hemicellulose.

### Sugar Beet Pulp Obtained or Obtainable by the Method According to the Second Aspect

In a third aspect, the invention concerns sugar beet pulp capable of absorbing and/or holding an amount of water that is at least 14 times the dry weight of the sugar beet pulp, obtained or obtainable by the method according to the second aspect.

Method of Loading Sugar Beet Pulp with Further Food-Grade Ingredients, Such as Protein

The inventors have unexpectedly found that sugar beet pulp according to the first aspect or according to the third aspect can, due to its increased water absorption capacity and water holding capacity, be effectively loaded with further food-grade ingredients, particularly with soluble protein up to high loads, such as for example 70 wt. % protein on dry matter.

Loading with drugs or pesticides is also within the scope of the invention. In what follows, the wording ‘(loaded with further) food-grade ingredients’ can be replaced with ‘(loaded with) drugs or pesticides’.

Accordingly, the ‘intermediate product’ of the sugar beet pulp according to the first aspect or according to the third aspect can be loaded with further food-grade ingredients, preferably with soluble protein, to provide a ‘final product’.

A fourth aspect of the invention concerns a method for loading the sugar beet pulp according to the first aspect or according to the third aspect with further food-grade ingredients, said method comprising the steps of:
(i) providing the sugar beet pulp according to the first aspect or according to the third aspect;
(ii) providing further food-grade ingredients;
(iii) adding the further food-grade ingredients provided in step (ii) to the sugar beet pulp provided in step (i), preferably followed by mixing; and
(iv) contacting the sugar beet pulp and the further food-grade ingredients in the mixture provided in step (iii) to load the sugar beet pulp with further food-grade ingredients.

This loading can be performed by contacting the, preferably only partially hydrated, sugar beet pulp according to the first aspect or according to the third aspect with an aqueous solution of water-soluble further food-grade ingredients. It is, however, also possible to perform this loading with further food-grade ingredients that are water-insoluble or only partially water-soluble by contacting the, preferably only partially hydrated, sugar beet pulp according to the first aspect or according to the third aspect with an oil-in-water (micro) emulsion containing the further food-grade ingredients in the oil phase. As will be appreciated by those skilled in the art, when using an oil-in-water (micro) emulsion, water-soluble, water-insoluble and only partially water-soluble further food-grade ingredients can be loaded at the same time.

This loading can also be performed by contacting the, preferably fully hydrated, sugar beet pulp according to the first aspect or according to the third aspect with a dry powder of water-soluble further ingredients.

Non-limiting examples of further food-grade ingredients are chosen from the group consisting of proteins, salts, flavourings, colourants and preservatives or chosen from the group consisting of vitamins, minerals, proteins, salts, flavourings, colourants and preservatives.

In a preferred embodiment, the further food-grade ingredients are proteins. Accordingly, in a preferred embodiment, the method of the fourth aspect is a method for loading the sugar beet pulp according to the first aspect or according to the third aspect with protein, said method comprising the steps of:
(i) providing the sugar beet pulp according to the first aspect or according to the third aspect;
(ii) providing soluble protein that can be immobilized in the sugar beet pulp provided in step (i);
(iii) adding the soluble protein provided in step (ii) to the sugar beet pulp provided in step (i), preferably followed by mixing;
(iv) contacting the sugar beet pulp and the protein in the mixture provided in step (iii) to load the sugar beet pulp with protein at conditions under which the protein remains soluble; and
(v) immobilizing at least part of the protein in the sugar beet pulp.

In a preferred embodiment, the sugar beet pulp loaded with protein obtained in step (v) comprises at least 15 wt. % of protein, based on the dry weight of the sugar beet pulp loaded with protein obtained in step (v), more preferably at least 18 wt. %, even more preferably at least 25 wt. %, such as at least 30 wt. %, at least 35 wt. %, at least 40 wt. %, at least 44 wt. %, at least 46 wt. %, at least 48 wt. %, at least 50 wt. %, at least 52 wt. %, at least 54 wt. %, at least 56 wt. %, at least 58 wt. %, at least 60 wt. %, at least 62 wt. %, at least 64 wt. %, at least 66 wt. %, at least 68 wt. %, at least 70 wt. % or at least 72 wt. %.

In another preferred embodiment, the sugar beet pulp loaded with protein obtained in step (v) comprises at least 1 wt. % of protein other than sugar beet protein, based on the dry weight of the sugar beet pulp loaded with protein obtained in step (v), more preferably at least 5 wt. %, even more preferably at least 10 wt. %, such as at least 15 wt. %, at least 20 wt. %, at least 25 wt. %, at least 30 wt. %, at least 35 wt. %, at least 40 wt. %, at least 45 wt. %, at least 50 wt. %, at least 52 wt. %, at least 54 wt. %, at least 56 wt. %, at least 58 wt. %, at least 60 wt. % or at least 62 wt. %.

The wording ‘comprises at least xx wt. % of protein, based on the dry weight of the sugar beet pulp loaded with protein obtained in step (v)’ refers to the weight of protein as determined using the Kjeldahl method with a conversion factor of 6.25 divided by the dry weight of the sugar beet pulp loaded with protein obtained in step (v).

In another preferred embodiment, the sugar beet pulp loaded with protein obtained in step (v) comprises between 15 and 80 wt. % of protein, based on the dry weight of the sugar beet pulp loaded with protein obtained in step (v), more preferably between 18 and 80 wt. %, even more preferably between 25 and 80 wt. %, such as between 30 and 80 wt. %, between 35 and 80 wt. % or between 40 and 80 wt. %.

In yet another preferred embodiment, the sugar beet pulp loaded with protein obtained in step (v) comprises between 1 and 70 wt. % of protein other than sugar beet protein, based on the dry weight of the sugar beet pulp loaded with protein obtained in step (v), more preferably between 5 and 70 wt. %, even more preferably between 10 and 70 wt. %, such as between 15 and 70 wt. %, between 20 and 70 wt. % or between 25 and 70 wt. %.

In an embodiment, the constituents of the sugar beet pulp provided in step (i) comprise, based on dry matter of the sugar beet pulp, 15-35 wt. %, preferably 15-30 wt. %, more preferably 18-26 wt. % cellulose, 15-40 wt. %, preferably 20-38 wt. %, more preferably 22-35 wt. % hemicellulose, 15-35 wt. %, preferably 20-30 wt. %, more preferably 21-27 wt. % pectin, 5-15 wt. % protein, less than 5 wt. % lignin, less than 5 wt. % sugars, less than 6 wt. % of ash and less than 1 wt. % fat.

There are generally two ways of loading the sugar beet pulp according to first or third aspect with protein; ‘dry protein loading’ and ‘wet protein loading’. In dry protein loading, the sugar beet pulp is contacted with dry protein powder. The inventors have found that dry loading can advantageously be performed on sugar beet pulp that is fully hydrated. So, when dry protein loading is performed, the sugar beet pulp is typically not subjected to a step of removing water by pressing, drying or a combination thereof. Sieving sugar beet pulp to remove ‘free water’ is however preferred when dry loading is performed.

In an embodiment wherein dry loading is performed, the sugar beet pulp provided in step (i) preferably has a water content of between 90 and 97 wt. %, based on the weight of the sugar beet pulp, such as between 94 and 97 wt. %

In wet protein loading, the sugar beet pulp is contacted with an aqueous protein solution. The inventors have found that wet loading can advantageously be performed on sugar beet pulp that is not fully hydrated. So, when wet protein loading is performed, the sugar beet pulp is preferably subjected to a step of removing water by sieving, pressing, drying or a combination thereof.

In an embodiment wherein wet loading is performed, the sugar beet pulp provided in step (a) preferably has a water content of between 80 and 94 wt. %, based on the weight of the sugar beet pulp, such as between 85 and 93 wt. %.

In step (ii) of the process as defined herein, ‘soluble protein that can be immobilized’ is provided. As is well known to the skilled person, many proteins that have been isolated from their corresponding source in their native state are water soluble and may be used as techno-functional ingredients in the preparation of foodstuffs, for example to provide (thermo) gelling, foaming, water-binding or emulsification properties. This functionality is typically (reversibly or irreversibly) lost by subjecting the native protein to for example heat, extreme pH, a change in pH to the isoelectric point or a combination thereof, resulting in at least partial denaturation, precipitation and/or coagulation of the protein.

In a preferred embodiment, the aqueous solubility of the soluble protein provided in step (ii) that can be immobilized in the sugar beet pulp provided in step (i) is at least 20%, more preferably at least 50%, still more preferably at least 70%, yet more preferably at least 90%, at pH=7.0 and T=20° C., as measured in accordance with the analytical protocol defined in the experimental section.

In another preferred embodiment, the aqueous solubility of the soluble protein provided in step (ii) that can be immobilized in the sugar beet pulp provided in step (i) is between 20 and 100%, more preferably between 50 and 100%, still more preferably between 70 and 100%, yet more preferably between 90 and 100%, at pH=7.0 and T=20° C., as measured in accordance with the analytical protocol defined in the experimental section.

In a preferred embodiment, the aqueous solubility of the soluble protein provided in step (ii) that can be immobilized in the sugar beet pulp provided in step (i) is at least 20%, more preferably at least 50%, still more preferably at least 70%, yet more preferably at least 90%, at pH=3.0 and T=20° C., as measured in accordance with the analytical protocol defined in the experimental section.

In another preferred embodiment, the aqueous solubility of the soluble protein provided in step (ii) that can be immobilized in the sugar beet pulp provided in step (i) is between 20 and 100%, more preferably between 50 and 100%, still more preferably between 70 and 100%, yet more preferably between 90 and 100%, at pH=3.0 and T=20° C., as measured in accordance with the analytical protocol defined in the experimental section.

In a preferred embodiment, the soluble protein provided in step (ii) that can be immobilized in the sugar beet pulp provided in step (i) is selected from the group consisting of vegetable proteins, including proteins from pulses, legumes, oilseeds, algae and kelp; proteins from microorganism, including proteins from yeast, moulds and fungi; animal protein, including whey protein, chicken-egg protein and proteins form insects; hydrolysates thereof; and combinations thereof.

In a very preferred embodiment, the soluble protein provided in step (ii) that can be immobilized in the sugar beet pulp provided in step (i) is selected from the group consisting of potato protein, rubisco, protein from lentils, pea protein, wheat protein, protein from barley, protein from rice, soy protein, fava protein, protein from chickpeas, chicken-egg protein, whey protein, canola protein, lupin protein, chickpea protein, almond protein, sunflower protein, hydrolysates thereof and combinations thereof, even more preferably selected from the group consisting of potato protein, fava protein, pea protein, protein from lentils, whey protein, hydrolysates thereof and combinations thereof.

In an embodiment, the soluble protein provided in step (ii) that can be immobilized in the sugar beet pulp provided in step (i) has a molecular weight between 3 and 650 kDa, as measured using Size Exclusion Chromatography (SEC), such as between 3 and 500 kDa, between 3 and 450 kDa, between 3 and 420 kDa, between 3 and 400 kDa, between 3 and 380 kDa, between 50 and 650 kDa, between 100 and 500 kDa, between 150 and 450 kDa, between 170 and 420 kDa, between 180 and 400 kDa or between 190 and 380 kDa.

In step (iii) of the process as defined hereinbefore, the soluble protein provided in step (ii) and the sugar beet pulp provided in step (i) are added, preferably followed by mixing.

In an embodiment, the soluble protein provided in step (ii) and the sugar beet pulp provided in step (i) are applied in step (iii) in a weight ratio of between 1:0.05 (protein: sugar beet pulp) and 1:1, on dry matter basis, preferably in a weight ratio of between 1:0.1 and 1:0.5, on dry matter basis.

Step (iii) preferably comprises mixing, for example gentle stirring, of the ingredients.

In an embodiment, the sugar beet pulp provided in step (i) is loaded with different soluble proteins that can be immobilized in the sugar beet pulp.

In an embodiment, the soluble protein provided in step (ii) is added to the sugar beet pulp in step (iii) as an aqueous solution (‘wet protein loading’). The aqueous solubility of the protein depends on temperature and pH and on the protein species. It is within the skills of the artisan to choose the optimum conditions. In this embodiment, the total amount of soluble protein, based on dry weight, to be added to the sugar beet pulp is typically in excess of the intended amount of soluble protein to be loaded into the sugar beet pulp. In this embodiment, the protein provided in step (ii) is preferably added to the sugar beet pulp in step (iii) as an aqueous solution in a weight ratio of between 1:0.05 and 1:0.3, on dry matter basis, preferably in a weight ratio of between 1:0.1 and 1:0.2, on dry matter basis.

In another preferred embodiment, the soluble protein provided in step (ii) is added to the sugar beet pulp in step (iii) as a dry powder (‘dry protein loading’), preferably a dry powder having a particle size distribution characterized by a Sauter mean diameter (D[3,2]) of between 10 and 100 μm, as determined with a laser diffraction particle size analyzer.

In this embodiment, the soluble protein provided in step (ii) is preferably added to the sugar beet pulp in step (iii) as a dry powder in a weight ratio of between 1:0.1 and 1:1, on dry matter basis, preferably in a weight ratio of between 1:0.2 and 1:0.5, on dry matter basis.

In step (iv) of the process as defined hereinbefore, the sugar beet pulp and the soluble protein in the mixture provided in step (iii) are contacted to load the sugar beet pulp with protein at conditions under which the protein remains soluble. It is important that the protein remains sufficiently soluble during loading because this allows the protein to enter the matrix of the sugar beet pulp as far as possible. (Partly) immobilized protein cannot be loaded deep into the sugar beet pulp. The definition of ‘soluble protein’ in the context of step (ii) equally applies to step (iv).

Aqueous solubility of proteins typically depends on pH and on temperature. It is within the skills of the artisan to choose the most appropriate conditions to realize efficient loading and/or high loads for different soluble proteins. The pH can for example be adjusted by adding 1 M NaOH or by adding concentrated lactic acid.

In an embodiment wherein ‘wet protein loading’ is performed, the sugar beet pulp and the soluble protein in the mixture provided in step (iii) are preferably contacted at least 1 minute, more preferably at least 5 minutes, even more preferably at least 30 minutes, still more preferably at least 60 minutes, yet more preferably at least 120 minutes, such as between 1 minute and 12 hours or between 5 minutes and 240 minutes.

In an embodiment wherein ‘dry protein loading’ is performed, the sugar beet pulp and the soluble protein in the mixture provided in step (iii) are preferably contacted at least 1 minute, more preferably at least 5 minutes, even more preferably at least 1 hour, still more preferably at least 4 hours, such as between 5 minutes and 24 hours, between 1 hour and 24 hours or between 8 hours and 24 hours.

In another preferred embodiment, the sugar beet pulp and the soluble protein in the mixture provided in step (iii) are contacted at a temperature between 4 and 60° C., more preferably at a temperature between 4 and 40° C., even more preferably at a temperature between 4 and 20° C.

In another preferred embodiment, the sugar beet pulp and the protein in the mixture provided in step (iii) are contacted at a pH between 6 and 9, such as a pH between 6.5 and 8 or a pH between 6.5 and 7.5

In yet another preferred embodiment, the sugar beet pulp and the protein in the mixture provided in step (iii) are contacted at a pH between 2 and 4, such as a pH between 2.5 and 3.5 or a pH between 3 and 4.

Step (iv) can comprise mixing, for example gentle stirring, of the ingredients.

Step (v) concerns immobilizing at least part of the protein in the sugar beet pulp. The immobilization of the proteins in the sugar beet pulp has the advantage that the sugar beet pulp loaded with protein can be rehydrated, after an optional drying step, without leaking of the protein from the sugar beet pulp.

Immobilization conditions are not identical for each and every type of protein. It is within the skills of the artisan to choose the most appropriate conditions to realize efficient immobilization.

In an embodiment, step (v) of immobilizing at least part of the protein in the sugar beet pulp is performed by:
(I) heating the sugar beet pulp loaded with protein provided in step (iv) to a temperature of between 85 and 100° C., preferably between 9° and 100° C., for at least 1 minute, such as between 1 and 5 minutes; or
(II) subjecting the sugar beet pulp loaded with protein provided in step (iv) to an acidic solution having a pH of between 4 and 5, preferably to an acidic solution having a pH of between 4.2 and 4.8, preferably for at least 1 minute, such as between 1 and 5 minutes; or
(III) subjecting the sugar beet pulp loaded with protein provided in step (iv) to a pH equal to the isoelectric point; or
(IV) a combination of (I) and (II); or
(V) a combination of (I) and (III).

In a preferred embodiment, the protein is completely immobilized in step (v). In another preferred embodiment, the protein is completely denatured in step (v). In yet another preferred embodiment, the protein is completely precipitated in step (v). In yet another preferred embodiment, the protein is completely flocculated in step (v). In still another preferred embodiment, the protein is completely coagulated in step (v).
Option (I) is the most preferred, because it does not require the addition of chemicals, resulting in a less processed product, which is preferred for food applications.
Option (I) is preferably performed in the presence of salts, preferably in the presence of food-grade salts, such as NaCl or calcium salts.

In an embodiment, the method further comprises step (vi) of drying the sugar beet pulp loaded with protein obtained in step (v). Drying may help to increase the microbiological stability of the product, which is preferred for food applications.

In a preferred embodiment, step (vi) of drying is performed to obtain a product having a water activity (AW) between 0.10 and 0.80, more preferably between 0.20 and 0.76, even more preferably between 0.30 and 0.60, as measured at 25° C. with a Lab Master-aw neo water activity measurement device (Novasina AG).

In an embodiment, the sugar beet pulp loaded with protein obtained in step (v) or the dried sugar beet pulp loaded with protein obtained in step (vi) is subsequently rehydrated in step (vii), for example in order to be applied as a food product or as a food ingredient. In embodiments, the time in between step (v) or (vi) and rehydration step (vii) can be up to 1 day, up to 15 days, up to 1 month or up to 5 months.

As shown in the appended examples, the inventors have unexpectedly found that the sugar beet pulp according to the invention loaded with protein according to the invention can be rehydrated without substantial loss of protein.

Sugar Beet Pulp Loaded with Further Food-Grade Ingredients

In a fifth aspect, the invention concerns sugar beet pulp loaded with further food-grade ingredients, preferably loaded with protein, obtainable or obtained by the method of the fourth aspect.

To the best of the knowledge of the inventors, the sugar beet pulp loaded with further food-grade ingredients, preferably loaded with protein, obtainable or obtained by the method of the fourth aspect is novel over the prior art because it comprises sugar beet pulp having improved water-holding capacity and water-absorption capacity.

### Food Products

A sixth aspect concerns a food product comprising or consisting of the sugar beet pulp according to the first or third aspect, or the sugar beet pulp loaded with further food-grade ingredients according to the fifth aspect.

In a preferred embodiment, the food product comprises between 0.05 and 99.9 wt. %, based on the weight of the food product, of the sugar beet pulp according to the first aspect, the sugar beet pulp according to the third aspect, or the sugar beet pulp loaded with further food-grade ingredients according to the fifth aspect, more preferably between 0.05 and 95 wt. %, such as 0.05 and 90 wt. %, between 0.05 and 80 wt. %, between 0.05 and 70 wt. %, between 0.05 and 60 wt. %, between 0.05 and 50 wt. %, between 0.05 and 40 wt. % or between 0.05 and 30 wt. %.

In another preferred embodiment, the food product comprises between 5 and 99.9 wt. % of the sugar beet pulp according to the first aspect, the sugar beet pulp according to the third aspect or the sugar beet pulp loaded with further food-grade ingredients according to the fifth aspect, based on the weight of the food product, more preferably between 10 and 99.9 wt. %, such as between 20 and 99.9 wt. %, between 30 and 99.9 wt. %, between 40 and 99.9 wt. %, between 50 and 99.9 wt. %, between 60 and 99.9 wt. % or between 70 and 99.9 wt. %.

The food product can be in any form known in the art, with the proviso that the form contains the sugar beet pulp according to the first or third aspect, or the sugar beet pulp loaded with further food-grade ingredients according to the fifth aspect. Examples include liquids, such as dispersions, creams, emulsions and solutions, and solids, such as granules, flakes, foams, gels or powders.

Preferred, but non-limiting, examples of food products are selected from the group consisting of meat substitutes or alternatives, fish substitutes or alternatives, breakfast cereals, cereal bars, pastry, snacks and salads or selected from the group consisting of meat substitutes or alternatives, fish substitutes or alternatives, hybrid meat and/or hybrid fish food products, soups, dressings, sauces, dairy products, fruit preparations, breakfast cereals, cereal bars, bakery products, snacks and salads.

Examples of bakery products include bread, flatbread, crackers, brioche, pizza dough/crust, quiche crust, wraps, marzipan, cake, cookies, muffins and pastry.

Examples of sauces include mayonnaise.

Meat alternatives include vegetarian hotdog, vegetarian Frankfurter, vegan Italian seitan sausage, seaweed nugget, falafel burger or ball, vegetarian croquette and vegetarian bitterbal.

Examples of dairy products include yoghurt, smoothies and ice cream.

Snacks are preferably chosen from the group consisting of plant-based meat snacks, vegan meat sticks, pizza bites and vegan protein bites.

In other embodiments, the food product is a vegetarian or vegan food product, preferably a vegetarian or vegan meat substitute or alternative, fish substitute or alternative, breakfast cereal, cereal bar, pastry, snack or salad. In other embodiments, the food product does not comprise animal-derived ingredients.

In a preferred embodiment, the food product is a burger, more preferably a vegetarian or vegan burger. In an embodiment, the raw burger, i.e. before cooking, baking and/or frying, consists of the following ingredients, based on the total weight of the burger:
between 40 and 70 wt. % of water;
between 5 and 25 wt. % of the sugar beet pulp, based on dry weight, according to the first or third aspect, or of the sugar beet pulp loaded with further food-grade ingredients according to the fifth aspect;
between 0.5 and 2 wt. % of salt;
between 5 and 20 wt. % of fats or oils;
between 1 and 6 wt. % of techno-functional protein;
between 5 and 25 wt. % of nutritional protein; and
between 1 and 15 wt. % of further ingredients.

As will be appreciated by those skilled in the art, based on the present disclosure, the sugar beet pulp according to the first or third aspect, or the sugar beet pulp loaded with further food-grade ingredients according to the fifth aspect comprises at least some water. However, in the above recipe, for reasons of clarity, water and dry weight of sugar beet pulp have been defined separately, although they are or may be added as one ingredient.

### Uses

A seventh aspect of the invention concerns the use of the sugar beet pulp according to the first or third aspect as an ingredient in a food product or as a carrier for further food-grade ingredients, preferably further food-grade ingredients chosen from the group consisting of proteins, salts, flavorings, colourants and preservatives or chosen from the group consisting of vitamins, minerals, proteins, salts, flavourings, colourants and preservatives.

An eighth aspect of the invention concerns the use of the sugar beet pulp according to the first or the third aspect or of the sugar beet pulp loaded with further food-grade ingredients according to the fifth aspect:
(a) as a texturizer in food products;
(b) as a water retainer in food products;
(c) as a water absorber in food products;
(d) as a fat replacer in food products; or
(e) a combination of two or more of (a)-(d).

### EXAMPLES

Method for Measuring the Aqueous Solubility at pH=7.0 or pH=3.0 and T=20° C.

The aqueous solubility of protein at pH=7.0 (or pH=3.0) and at a temperature of 20° C. was tested using the following protocol:
(a) a sample of protein is added to demineralized water in an amount of 5 wt. %, based on the total weight of all ingredients;
(b) the composition of step (a) is stirred for one hour at a temperature of 20° C.;
(c) the pH of the composition obtained in step (b) is measured;
(d) if the pH measured in step (c) differs from 7.0 (or 3.0), the pH is adjusted to 7.0 (or 3.0) with 1 M HCl or 1 M NaOH;
(e) a first subsample of the composition obtained in step (d) is taken and the total protein content (A) is determined (g/L) using the Kjeldahl method with a conversion factor of 6.25;
(f) a second subsample of the composition obtained in step (d) is taken, is centrifuged for 10 minutes at 4000 G (Beckman Coulter Avanti J-E centrifuge), the resulting supernatant is isolated and its total protein content (B) is determined (g/L) using the Kjeldahl method with a conversion factor of 6.25;
(g) the solubility of the protein is calculated at pH=7.0 (or 3.0) and T=20° C. from:

$$\% Solubility = ( B ) / ( A ) \cdot 100 \% .$$

### Measurement of the Firmness

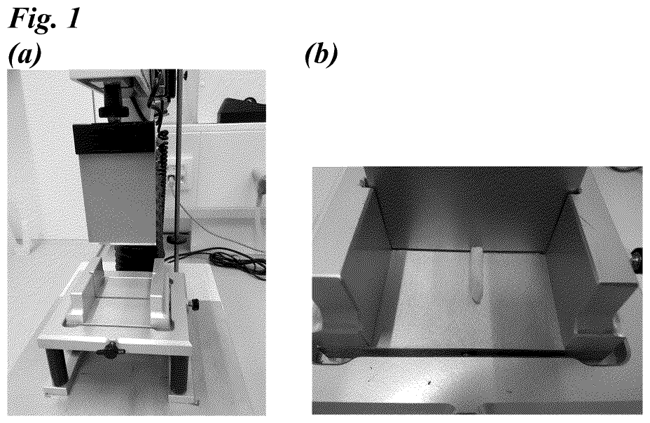

The average firmness (or hardness or toughness) of a sample of sugar beet pulp at 20° C. is determined with a texture analyzer (Stable Micro Systems Ltd, TA-XT Plus) equipped with a 5 kg load cell, a slotted base plate and a standard knife/blade set (HDP/BS) consisting of a reversible knife edge and a Warner Bratzler blade (see FIG. 1a for the experimental setup), in accordance with the following analytical procedure:
i) in a first step, 50 samples of sugar beet cossettes are provided, each sample having a length of several centimeters, a width of 3.8 mm and a height of 2.8 mm;
ii) a sample is placed on the slotted base plate of the texture analyzer in a direction wherein the ‘length of the sample’ is positioned perpendicularly to the direction of movement of the standard blade set (see FIG. 1b for the positioning of the sample);
iii) a firmness test is performed at 20° C. on the sample by pushing the knife/blade set downwards at a speed of 2 mm/s all the way through the sample and by recording the force-distance curve, wherein the maximum force (expressed in g) in the force-distance curve is taken as the firmness of the sample;
iv) steps (ii) and (iii) are repeated for all 50 samples and the values for the maximum force are averaged to provide the average firmness (expressed in g) of the sample.

### Measurement of the Repeated Water Desorption-Absorption Power

The repeated water desorption-absorption power of sugar beet pulp is determined using the following protocol. The following materials were used: polyamide cloth (36 g when dry, 72 g when wet), polystyrene box (22 g), 5 L bucket (350 g). The sugar beet pulp to be tested typically has a high water content, such as for example more than 60 wt. %, preferably more than 90 wt. %.

The test was performed using a Hafico (also available as Gezang Tinctuurpers met handpomp, type HP2-Hand) hydraulic hand press for lab use. With this hand press, a pressure of 100 bar is equivalent to 5 bar on the piston. The working sequence is as follows:
In a first step, the weight of the sugar beet pulp sample is determined, its dry matter content and its water holding capacity and the weight of the bucket filled with water;
In a second step, the sugar beet pulp sample is provided in the polyamide cloth. The filled polyamide cloth is then pressed by closing the hydraulic valve and by manual pumping until the hydraulic pressure reaches 100 bar. The hydraulic pressure is maintained at 100 bar for 1 minute. By doing so, press juice is released from the sugar beet pulp sample through the polyamide cloth into a polystyrene box. The individual weights of the press juice and of the pressed filled polyamide cloth are determined;
In a third step, the pressed filled polyamide cloth is submersed in a known water weight in the 5 L bucket for 1 minute, followed by removing the rehydrated filled polyamide cloth from the water with draining any free water for 1 minute by dripping. The weight of the bucket filled with water is determined along with the weight of the rehydrated filled polyamide cloth;
In a fourth step, the water content of the rehydrated sugar beet pulp sample is determined and is compared to the water content of the original sugar beet pulp and to the water holding capacity.
These 4 steps are repeated in this sequence 4 times.

### Measurement of the Soil, Sand and Clay Content

The combined content of soil, sand and clay in a sample of sugar beet pulp is determined by measuring the HCl-unsolvable ash in accordance with NEN-ISO 5985:2003. This amount of soil, sand and clay is then expressed as a weight percentage based on the dry weight of the sugar beet pulp, i.e.:

$$( weight of HCl - unsolvable ash ) / ( dry weight sugar beet pulp ) * 100 \% .$$

### Method for Measuring the Dry Matter and Water Content

The dry matter content and water content of a sample is determined by subjecting a sample with a first ‘wet weight’ to drying at a temperature of 80° C. during 20 hours in a hot air oven, followed by a temperature of 105° C. during 2 hours. The dry matter content and water content is then determined from the weight loss.

### Method for Measuring Water Holding Capacity

The water holding capacity of a sample is determined by soaking the sample in water for 40 minutes. After this soaking step, the sample is fully hydrated. Any ‘free’ water is then removed by shaking the hydrated sample on a sieve. The mass of the fully hydrated sample without free water is then determined. The water holding capacity (gram water/gram dry matter) can then be determined by also measuring the dry matter content of the sample.

### Method for Measuring the Protein Content

The protein content of a sample is determined using the Kjeldahl method with a conversion factor of 6.25.

### Method for Measuring Water Uptake on Rehydration (Water Absorption Capacity)

Samples of sugar beet pulp or sugar beet pulp loaded with protein were dried in a hot-air oven at a temperature of 90° C. until no further weight loss could be observed anymore. The thus dried samples were rehydrated in an excess amount of water at room temperature. The weight of the sugar beet particles loaded with protein during rehydration was measured several times during the rehydration process. After about one hour, the sugar beet pulp or the sugar beet pulp loaded with protein had reached a constant weight. The total water uptake on rehydration [gram water per gram dry matter] is calculated from the total weight gain of a sieved sample during rehydration and from the water content of the sugar beet pulp or sugar beet particles loaded with protein before rehydration.

### Method for Measuring the Water Activity (AW) of Dried Samples

Samples of sugar beet pulp loaded with protein are dried in a hot-air oven at a temperature of 90° C. for 6 hours. The water activity (AW) of the thus dried samples is measured with a Lab Master-aw neo water activity measurement device (Novasina AG) at 25° C.

### Method for Measuring Particle Size

The particle size of sugar beet pulp particles having a median particle size, in fully hydrated form, in the order of between 500 μm and 10 mm can be measured using wet sieving using the following protocol. The sizes of the apertures of the sieves may be varied, depending on the size of the particles. For example, if the median particle size is larger than 2 mm, then one or more sieves having apertures of >2 mm should be included.

The sugar beet pulp particles were first fully hydrated by soaking them in an excess amount of water for 30 minutes. A stack of sieves were combined in the following order from the top to the bottom: a top sieve having apertures of 2 mm, a sieve having apertures of 1.4 mm, a sieve having apertures of 1 mm, a sieve having apertures of 710 μm, a sieve having apertures of 500 μm, a sieve having apertures of 355 μm and a receiving tray.

The fully hydrated sugar beet pulp particles were fed to the top sieve and the combination of sieves was shaken for 5 minutes under continuous addition of water to the top sieve to classify the fully hydrated sugar beet pulp particles. After the classification, the mass of the fully hydrated sugar beet pulp particles remaining on each of the sieves was calculated as a weight percentage with respect to the total weight of the fully hydrated sugar beet pulp particles fed to the top sieve to determine the particle size distribution. By integrating weight percentages on the sieves in descending order of the aperture sizes, a relationship between the apertures of the sieves and the cumulative weight percentages of the fully hydrated sugar beet pulp particles remaining on the sieves was obtained. From this relationship, the particle size corresponding to 50% by mass of the cumulative mass percentage was taken as the median particle size.

The particle size of sugar beet pulp particles having a median particle size (D50), in fully hydrated form, in the order of between 100 μm and 850 μm, can be measured using liquid dispersion laser diffraction in a Malvern Mastersizer 3000 (refractive index material: 1.53, refractive index dispersant: 1.33, absorption index: 0.1) coupled with a Malvern Hydro MV. The amount of a sample of fully hydrated sugar beet pulp particles added to a measuring chamber filled with water is steadily increased until the obscuration is within the required range after which the particle size distribution is measured. The stirrer speed of the Malvern Hydro MV was 2500 rpm. The resulting median particle diameter D50 is a volume median, based on a volume distribution. The median particle diameter D50 is the diameter where half of the population of sugar beet pulp particles lies below. This volume median particle diameter is often referred to in the art as Dv50 or D_{v0.5}.

### Example 1: Water Uptake and Release with and without Different Pretreatment Steps

Raw sugar beets were sliced into particles having a size of 4×4×6 mm. Different samples of the raw sugar beet particles (Samples 2-8) were subjected to different pretreatment steps, as indicated in Table 1. Sample 1 was not subjected to any pretreatment (Reference).

Some samples were subjected to pulsed electric field (PEF) treatment using a Dil, Elcrack HVP 30, bath TB 140 device (field strength: 1 kV/cm, conductivity treatment water: 1700 uS/cm, temperature treatment water: 25° C., belt speed 0.04 m/s).

The heat treatment at 70° C. and 120 minutes took place in an excess of water to mimic the conditions in a diffusion tower. The treatment at 100° C. and 10 minutes directly followed the heat treatment at 70° C. and 120 minutes in the same excess of water. Samples that were pretreated with an excess of water were sieved to remove ‘free water’. The pretreated sugar beet pulp had a water content, based on the weight of the pretreated sugar beet pulp, as indicated in Table 1.

The effect of the different pretreatments on the water uptake and on the amount of water released during a subsequent pressing step (tincture press, Gezang (Hafico), the Netherlands; operated at 9 bar pressure during 5 minutes) was investigated. The amount of water released (in g) from 200 gram of (pretreated) sugar beet pulp is indicated in Table 1. The fraction (%) of the water that was released from 200 gram of sugar beet pulp on pressing, based on the total amount of water present before pressing, is also indicated in Table 1.

TABLE 1

| | | | | | Water | Water |
|---|---|---|---|---|---|---|
| | Temperature | PEF | | Initial | released | released |
| | [° C.]/ | treatment/ | | water | on | on |
| | time | time | Freezing/ | content | pressing | pressing |
| Sample # | [minutes] | [minutes] | thawing | [wt. %] | [g] | [%] |
| 1 | No | No | No | 75 | 25 | 16.7 |
| (Ref.) | | | | | | |
| 2 | No | No | Yes | 75 | 128 | 85.3 |
| 3 | No | Yes/1 | No | 85 | 85 | 50.0 |
| 4 | No | Yes/1 | Yes | 85 | 142 | 83.5 |
| 5 | 70/120 | No | No | 90 | 145 | 80.6 |
| 6 | 70/120 | No | Yes | 90 | 170 | 94.4 |
| 7 | 70/120 and | No | No | 95 | 159 | 83.7 |
| | 100/10 | | | | | |
| 8 | 70/120 and | No | Yes | 95 | 180 | 94.7 |
| | 100/10 | | | | | |

It was concluded that increasing amounts of heat applied during pretreatment had a positive effect on water uptake of the sugar beet pulp. Pretreatment with membrane disruption due to PEF alone or followed by freezing/thawing also had a positive effect on water uptake, even without heat treatment, i.e. on raw sugar beet particles.

It was further concluded that increasing amounts of heat applied during pretreatment had a positive effect on water release during pressing. Pretreatment with membrane disruption due to PEF and/or freezing/thawing also had a positive effect on water release during pressing, even without heat treatment, i.e. on raw sugar beet particles.

A combination of heat treatment followed by freezing/thawing had the most positive effect on water uptake and on water release during pressing.

### Example 2: Water Holding Capacity of Treated Spent Sugar Beet Pulp

Spent sugar beet pulp was sampled from a diffusion tower of Cosun Beet Company, Dinteloord, the Netherlands. The spent sugar beet pulp was obtained by washing and slicing sugar beets into so-called ‘cossettes’, subjecting the sugar beet cossettes to thermal cell disintegration and extraction in a diffusion tower. In said diffusion tower, sucrose along with other water-soluble ingredients were extracted from the thermally treated sugar beet cossettes by a warm aqueous diffusion process to obtain a so-called ‘raw juice’ or ‘diffusion juice’ at a temperature of between 65 and 75° C. and a residence time of between 30 and 180 minutes. This thermal treatment resulted in the denaturation of the cell membrane and partial disruption of cell wall structure of the remaining spent sugar beet pulp. The spent sugar beet pulp was subsequently cooked (100° C.) for 10 minutes in an excess of water, pressed, frozen, thawed, soaked in water for 10 minutes, again frozen and thawed, and finally soaked in water for 40 minutes. After this final soaking step the treated sugar beet pulp was fully hydrated. Any ‘free’ water was removed by shaking the product on a sieve.

The thus treated sugar beet pulp contained an amount of water that was 33 times the dry weight of the sugar beet pulp and had total content of mono- and disaccharides of less than 2 wt. %, based on dry weight of the sugar beet pulp.

### Example 3: Loading of Pretreated Spent Sugar Beet Pulp with Protein

Spent sugar beet pulp was sampled from a diffusion tower of Cosun Beet Company, Dinteloord, the Netherlands. The spent sugar beet pulp was obtained by washing and slicing sugar beets into so-called ‘cossettes’, subjecting the sugar beet cossettes to thermal cell disintegration and extraction in a diffusion tower. In said diffusion tower, sucrose along with other water-soluble ingredients were extracted from the thermally treated sugar beet cossettes by a warm aqueous diffusion process to obtain a so-called ‘raw juice’ or ‘diffusion juice’ at a temperature of between 65 and 75° C. and a residence time of between 30 and 180 minutes. This thermal treatment resulted in the denaturation of the cell membrane and partial disruption of the cell wall structure of the remaining spent sugar beet pulp.

Whey protein isolate (BiPro) was obtained from Davisco Foods Int. The aqueous solubility of the protein at pH=7.0 and T=20° C., measured in accordance with the analytical protocol as defined hereinbefore, was 93.5%.

Potato protein isolate (SolanicR 200) was obtained from Avebe B.V., the Netherlands. The aqueous solubility of the protein at pH=7.0 and T=20° C., measured in accordance with the analytical protocol as defined hereinbefore, was 97.7%.

Fava bean protein isolate (HQ Isolate) was obtained from Cosun, Dinteloord, the Netherlands. The aqueous solubility of the protein at pH=7.0 and T=20° C., measured in accordance with the analytical protocol as defined hereinbefore, was 93.0%. This fava bean protein isolate has the following specifications: protein (Nx6.25): 88%, carbohydrates: 4.0%, ash: 4.6%, fat: <1%, moisture: 2.9%.

Soy bean protein isolate (Clarisoy 100) was obtained from ADM, US. The aqueous solubility of this soy bean protein isolate at pH=7.0 and T=20° C. is very low. It does however have a considerable aqueous solubility at pH=3.0 and T=20° C., as measured in accordance with the analytical protocol as defined hereinbefore.

Soy TVP (Response 4410) was obtained from DuPont Nutrition & Biosciences.

### First Pretreatment of Spent Sugar Beet Pulp

Spent sugar beet pulp as defined supra was pretreated by washing with tap water, cooking at 100° C. for 5 minutes and freezing (−18° C. for 24 hours). The frozen spent sugar beet pulp was thawed in a micro wave oven and milled in a meat grinder to obtain spent sugar beet pulp having an average size of about 5×5×5 mm. The thus obtained spent sugar beet pulp was cooked again at 100° C. for 5 minutes in an excess amount of water. The term ‘excess of amount of water’ as used here means that the amount of water was higher than the amount that could be absorbed by the thus treated sugar beet pulp. The resulting wet spent sugar beet pulp was separated from ‘free water’ by sieving and had a water content of 95 wt. %, based on the weight of the wet spent sugar beet pulp. Since an excess amount of water was used during cooking, the wet spent sugar beet pulp was saturated with water (hydrated) to the maximum.

### Dry Protein Loading

The wet spent sugar beet pulp obtained after the first pretreatment step as described supra, having a water content of 95 wt. %, based on the weight of the wet spent sugar beet particles, was without further treatment step mixed with dry protein powder in a weight ratio (wet pretreated spent sugar beet particles): (dry protein powder) of 6:1. This is a weight ratio of 1:3.3 on dry matter basis. Mixing of both ingredient was performed manually with a spatula until a homogeneous mixture was obtained. This procedure was followed for (i) whey protein isolate, (ii) fava bean isolate and (iii) potato protein isolate. For (iv) soy protein isolate, a small amount of concentrated lactic acid (88%) was added dropwise during mixing until a pH of 3.0 was obtained. The resulting homogeneous mixtures (i)-(iv) were stored for at least 12 hours at a temperature of 5° C. to enable loading of the protein into the pretreated spent sugar beet pulp.

### Second Pretreatment of Spent Sugar Beet Pulp

The wet spent sugar beet pulp obtained after the first pretreatment step as described supra having a water content of 95 wt. %, based on the weight of the wet spent sugar beet pulp, was subjected to a second pretreatment step by subjecting them to pulp pressing at 9 bar for 5 minutes in a tincture press (Gezang (Hafico), the Netherlands), resulting in pressed pretreated spent sugar beet pulp having a water content of 90 wt. %, based on the weight of the pressed pretreated spent sugar beet pulp.

### Wet Protein Loading

Using (i) whey protein isolate, (ii) fava bean isolate, (iii) potato protein isolate and (iv) soy protein isolate, four concentrated (20 wt. %) protein solutions were prepared in demineralized water. Subsequently, 200 g of pressed spent sugar beet pulp obtained after the second pretreatment step as described supra, having a water content of 90 wt. %, based on the weight of the pressed pre-treated spent sugar beet particles, was dispersed in 1 kg of each of the concentrated protein solutions and mixed during one hour using an overhead stirrer. For soy protein isolate, a small amount of concentrated lactic acid (88%) was added dropwise during mixing until a pH of 3.0 was obtained. The pressed spent sugar beet pulp obtained after the second pretreatment step as described supra was thus mixed with concentrated protein solution in a weight ratio of 1:5. This corresponds to a weight ratio (wet pressed spent sugar beet pulp):(dry protein) of 1:1. This is a weight ratio of 1:10 on dry matter basis. The resulting dispersions were stored for at least 12 hours at a temperature of 5° C. to enable loading of the protein into the pre-treated spent sugar beet pulp. In a subsequent step, the sugar beet pulp loaded with protein was removed from the liquid phase by sieving.

### Immobilization Using Thermal Coagulation

Protein loaded into the pretreated spent sugar beet pulp was immobilized in the pretreated spent sugar beet pulp using thermal coagulation, i.e. denaturation and precipitation using heat.

In a first step, pretreated spent sugar beet pulp loaded with protein was put into a sieve and subjected to a washing step with water having a temperature of 100° C. (from a Quooker). This washing step partly removes protein that is present on the outer surface of the sugar beet pulp. This is an optional step, since it removes valuable protein from the outer surface that can be immobilized onto the pretreated spent sugar beet pulp. In a second step, the washed pretreated spent sugar beet pulp loaded with protein was immersed in an excess of boiling water with 0.2 wt. % of NaCl. After about 1 minute residence time, the sugar beet pulp loaded with protein was removed from the boiling water.

### Immobilization Using Precipitation at the Isoelectric Point

Protein loaded into the pretreated spent sugar beet pulp was immobilized in the pretreated spent sugar beet pulp using precipitation at the isoelectric point.

In a first step, pretreated spent sugar beet pulp loaded with protein was dispersed in an excess amount of water. For sugar beet pulp loaded with soy protein isolate, the pH was adjusted to 4.7 using 1M NaOH. For sugar beet pulp loaded with whey protein isolate, fava bean protein isolate and potato protein isolate, the pH was adjusted to 4.4 with concentrated lactic acid (88%).

### Analysis

The dry matter content of sugar beet pulp not loaded with protein (Reference) and after loading/immobilization was measured in accordance with the analytical protocol specified supra.

The reference sample (Reference) consisted of wet spent sugar beet pulp (subjected to the first pretreatment step) with a water content of 95 wt. % that was subsequently put into a sieve, subjected to a washing step with water having a temperature of 100° C. (from a Quooker), immersed in an excess of boiling water with 0.2 wt. % of NaCl for about 1 minute residence time, and was removed from the boiling water.

The Kjeldahl protein content of reference sample (Reference) was determined in accordance with the analytical protocol specified supra. The Kjeldahl protein content of sugar beet pulp after loading/immobilization was also measured in accordance with the analytical protocol specified supra. From these measurements, the Kjeldahl protein content [wt. %], based on the total wet and dry matter content of the sugar beet pulp loaded with protein can be determined. Results are presented in Table 2.

TABLE 2

| | | | | | | Protein |
|---|---|---|---|---|---|---|
| | | | | Dry | | (Kjeldahl) |
| | | | | matter | Protein | on dry |
| | | | Immobi- | content | (Kjeldahl) | matter |
| Protein | Name | Loading | lization | [wt. %] | [wt. %] | [wt. %] |
| Ref. | — | — | — | 5 | 0.46 | 9.3 |
| Whey | BiPro | Wet | Heat | 11.2 | 6.1 | 54.5 |
| | | Dry | Heat | 13.2 | 8.7 | 65.9 |
| Fava | HQ Isolate | Wet | Heat | 6.9 | 1.9 | 27.2 |
| | | Wet | pH | N.D. | N.D. | N.D. |
| | | Dry | Heat | 8.1 | 4.9 | 60.5 |
| | | Dry | pH | 9.9 | 7.1 | 71.7 |
| Potato | Solanic ® | Wet | Heat | 8.2 | 4.3 | 52.4 |
| | 200 | Wet | pH | N.D. | N.D. | N.D. |
| | | Dry | Heat | 9.4 | 5.5 | 58.5 |
| | | Dry | pH | N.D. | N.D. | N.D. |
| Soy | Clarisoy | Wet | Heat | 6.7 | 2.5 | 37.3 |
| | | Wet | pH | 7.3 | 3.2 | 43.8 |
| | | Dry | Heat | 6.9 | 2.8 | 40.6 |
| | | Dry | pH | 8.6 | 5.1 | 59.3 |

Sugar beet pulp loaded with whey protein isolate via the wet method wherein the protein was immobilized using heat (thermal coagulation) was dried in a hot-air oven at a temperature of 90° C. until no further weight loss could be observed anymore. Likewise, sugar beet pulp loaded with potato protein isolate via the wet method wherein the protein was immobilized using heat (thermal coagulation) was dried in a hot-air oven at a temperature of 90° C. until no further weight loss could be observed anymore. The water content and water activity (AW) of these dried products were measured in accordance with the analytical protocols defined supra and are presented in Table 3. As a reference, the water content and water activity (AW) of Soy TVP Response 4410 was measured.

The total water uptake on rehydration (g water per g dry matter) of dried sugar beet pulp loaded with whey protein isolate was measured in accordance with the analytical protocol defined supra. Likewise, the total water uptake on rehydration (g water per g dry matter) of dried sugar beet pulp loaded with potato protein isolate was measured in accordance with the analytical protocol defined supra. As a reference, the total water uptake on rehydration (g water per g dry matter) of Soy TVP Response 4410 was measured. Results are presented in Table 3. From the water content of the ‘dry’ products before water uptake and the water uptake itself, the total water content after rehydration can be calculated. Results are again presented in Table 3.

TABLE 3

| | | | | | Water | | |
|---|---|---|---|---|---|---|---|
| | | | | AW | content | Water | Water |
| | | | | value | before | uptake | content |
| | | | | before | water | [g | [g |
| | | | Immobi- | water | uptake | water/g | water/g |
| Protein | Name | Loading | lization | uptake | [wt. %] | DM] | DM] |
| Ref. | Soy TVP | — | — | 0.719 | 13.5 | 8.1 | 8.3 |
| (soy) | Response 4410 | | | | | | |
| Whey | BiPro | wet | heat | 0.760 | 16.6 | 12.9 | 13.1 |
| Potato | Solanic ® 200 | wet | heat | 0.748 | 15.1 | 9.7 | 9.9 |

It was concluded that the sugar beet pulp loaded with protein according to the present invention show increased water uptake and water content on rehydration as compared to the reference soy TVP. The dried sugar beet pulp loaded with protein according to the present invention was able to absorb an amount of water that is about 10 to 13 times its own dry weight. For example, 1 g dried sugar beet pulp loaded with whey protein having a water content of 16.6 wt. % was able to absorb 10.8 g water, resulting in a water uptake of 12.9 g water/[g dry matter] and a total water content of 13.1 g water/[g dry matter].

### Example 4: Loading Sugar Beet Pulp with Protein

The sugar beet pulp that had been subjected to the different pretreatment steps indicated in Table 1 was loaded with whey protein isolate using wet and dry protein loading followed by immobilization using thermal coagulation, as described in Example 3. The Kjeldahl protein content [wt. %], based on the total dry matter content of the sugar beet pulp loaded with protein, was determined. Results are presented in Table 4.

TABLE 4

| | | PEF/ | | | Kjeldahl |
|---|---|---|---|---|---|
| Sample | T [° C.]/ | Time | Freezing/ | | protein on dry |
| # | Time [min.] | [min.] | thawing | Loading | matter [wt. %] |
| 1 | No | No | No | Wet | 8.1 |
| | No | No | No | Dry | N.D. |
| 2 | No | No | Yes | Wet | 14.2 |
| | No | No | Yes | Dry | N.D. |
| 3 | No | Yes/1 | No | Wet | 10.5 |
| | No | Yes/1 | No | Dry | 11.2 |
| 4 | No | Yes/1 | Yes | Wet | 18.4 |
| | No | Yes/1 | Yes | Dry | 20.1 |
| 5 | 70/120 | No | No | Wet | 13.1 |
| | | No | No | Dry | 29.6 |
| 6 | 70/120 | No | Yes | Wet | 46 |
| | | No | Yes | Dry | 36.9 |
| 7 | 70/120 and | No | No | Wet | 40 |
| | 100/10 | No | No | Dry | 51.6 |
| 8 | 70/120 and | No | Yes | Wet | 55.9 |
| | 100/10 | No | Yes | Dry | 64.5 |

N.D. = not determined

It can be concluded from Table 4 that the freezing/thawing step considerably increased the protein load. Moreover, additional heating, particularly at 100° C., increased the protein load. Pretreatment wherein a heating step at 100° C. and a step of freezing/thawing were applied resulted in the highest protein load, both for wet and dry loading. PEF treatment, without a heating step and/or without a freezing/thawing step had a limited effect on protein load.

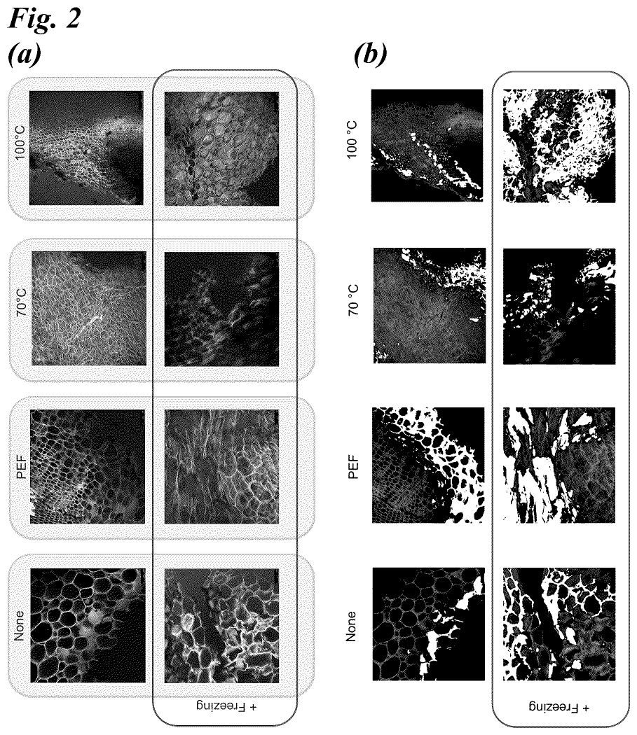

FIG. 2a depicts images made by confocal scanning laser microscopy of the sugar beet pulp loaded with whey protein using wet protein loading followed by immobilization using thermal coagulation. FIG. 2b is a copy of FIG. 2a wherein the colours have been changed slightly to highlight the immobilized whey protein in the matrix of the sugar beet pulp. The white areas in FIG. 2b correspond to whey protein, the grey areas to the matrix of the sugar beet pulp and the black areas to the background.

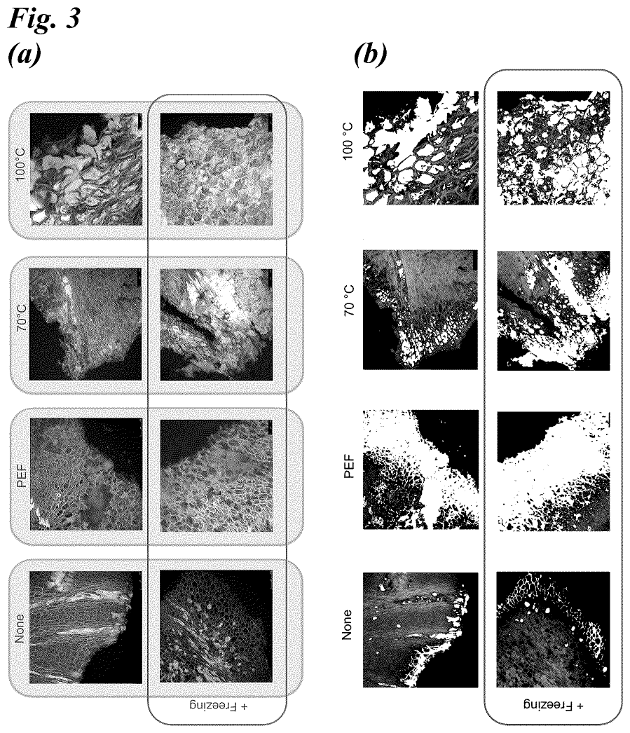

FIG. 3a depicts images made by confocal scanning laser microscopy of the sugar beet pulp loaded with whey protein using dry protein loading followed by immobilization using thermal coagulation. FIG. 3b is a copy of FIG. 3a wherein the colours have been changed slightly to highlight the immobilized whey protein in the matrix of the sugar beet pulp. The white areas in FIG. 3b correspond to whey protein, the grey areas to the matrix of the sugar beet pulp and the black areas to the background.

Sugar beet pulp pretreated according to Sample 8, loaded with whey protein isolate using dry loading and immobilized using thermal coagulation, was dispersed in an excess amount of tap water for 6 hours at a temperature of 20° C. As a reference example, sugar beet pulp pretreated according to Sample 8, loaded with whey protein isolate using dry loading without the subsequent immobilization step, was dispersed in an excess amount of tap water for 6 hours at a temperature of 20° C.

Afterwards, the Kjeldahl protein content [wt. %], based on the total dry matter content of the sugar beet pulp loaded with protein, was determined for both samples. The sample prepared without the immobilization step had a Kjeldahl protein content of 17.2 wt. %, based on the total dry matter content of the sugar beet particles loaded with protein. The sample prepared with the immobilization step had a Kjeldahl protein content of 59.7 wt. %, based on the total dry matter content of the sugar beet pulp loaded with protein, i.e. 93% of the protein was still present in the sugar beet pulp after 6 hours in water. It was concluded that the immobilization step effectively prevents leakage of the protein from the sugar beet pulp.

### Example 5

The firmness, toughness or hardness of sugar beet pulp pretreated in different ways was tested in accordance with the analytical protocol as defined hereinbefore.

Sample 9 concerns spent sugar beet pulp sampled from a diffusion tower of Cosun Beet Company, Dinteloord, the Netherlands, that was subsequently stored frozen (−18° C.). Before testing, Sample 9 was thawed in a microwave oven and soaked in an excess of water during 40 minutes.

Sample 10 concerns spent sugar beet pulp sampled from a diffusion tower of Cosun Beet Company, Dinteloord, the Netherlands, that was subsequently stored frozen (−18° C.). Sample 10 was thawed in a microwave oven and subsequently heated at 95° C. in an excess of water during 17 minutes.

Results are shown in Table 5. The additional heating step considerably reduces the firmness, resulting in advantageous organoleptic properties, particularly as regards bite, without adversely affecting the structural integrity of the pulp.

TABLE 5

| Sample | Firmness |
|---|---|
| # | [g] |
| 9 | 1117 |
| 10 | 465 |

### Example 6

The combined content of soil, sand and clay in samples of sugar beet pulp pretreated in different ways was determined by measuring the HCl-unsolvable ash in accordance with NEN-ISO 5985:2003 (see also the analytical protocol as defined hereinbefore).

Sample 11 concerns spent sugar beet pulp sampled from a diffusion tower of Cosun Beet Company, Dinteloord, the Netherlands. Sample 12 is based on Sample 11 which was subsequently washed. Sample 13 is based on Sample 12 which was subsequently heated in an excess of water (T=95° C.) for 20 minutes. Sample 14 is based on Sample 13 after cooling to ˜5° C. with removal of a water fraction comprising soil, sand and clay. Sample 15 is based on Sample 14 after freezing at around −20° C. Results are shown in Table 6.

TABLE 6

| Sample | HCl-unsolvable ash |
|---|---|
| # | [wt. %, based on dry matter] |
| 11 | 4.3 |
| 12 | 2.1 |
| 13 | 1.8 |
| 14 | 1.3 |
| 15 | 1.1 |

### Example 7

Microbial counts in samples of sugar beet pulp pretreated in different ways were determined. Sample 16 is based on Sample 11, after 16 hours residence time at a temperature of between 7° and 50° C. Sample 17 is based on Sample 16 which was subsequently washed and heated in an excess of water (T=95° C.) for 20 minutes. Results are shown in Table 7. It is clear from Table 7 that sugar beet pulp obtained directly from the diffusion tower is prone to microbial spoilage. A heating treatment at 95° C. for 20 minutes results in a product that is, from a microbial perspective, safe for human consumption.

TABLE 7

| | | Sample | Sample | Sample |
|---|---|---|---|---|
| Microorganism | Method | 11 | 16 | 17 |
| Total thermophilic bacteria | ISO 4833-1:2013 | 1600 | 5.5 · 10⁴ | <1 |
| count [CFU/g] | | | | |
| Total thermophilic spores | ICUMSA GS2_{/3}-49 | 30 | 5.4 · 10⁴ | <1 |
| count [CFU/g] | (1998) | | | |
| Total mesophilic bacteria | ISO 4833-1:2013 | 220 | 1.7 · 10⁵ | <1 |
| count [CFU/g] | | | | |
| Total mesophilic spores | NEN 6813:2014 nl | 180 | 2700 | <1 |
| count [CFU/g] | | | | |
| Total moulds count [CFU/g] | ISO 21527-1:2008 | <1 | 10 | <1 |
| Total yeast count [CFU/g] | ISO 21527-1:2008 | <1 | 1.1 · 10⁴ | <1 |
| Salmonella spp | ISO 6579-1:2017 | | | absent |
| [CFU/25 g] | | | | |
| Enterobacteriaceae | ISO 21528-1:2017 | | | absent |
| [CFU/25 g] | | | | |
| S. aureus [CFU/g] | ISO-6888-3:2003 | | | absent |
| Listeria spp [CFU/ 25 g] | NEN-EN-ISO 11290- | | | absent |
| | 1/2:2014 | | | |
| Listeria monocytogenes | NEN-EN-ISO 11290- | | | absent |
| [CFU/25 g] | 1/2:2014 | | | |
| B. cereus [CFU/g] | ISO 7932:2004 | | | <100 |

### Example 8: Vegetarian Burgers

Vegetarian burgers were produced with (a) sugar beet pulp and (b) sugar beet pulp loaded with protein that were produced as follows. Spent sugar beet pulp sampled from a diffusion tower of Cosun Beet Company, Dinteloord, the Netherlands, was washed with tap water, cooked in an excess of water (5 minutes, 100° C.) and frozen (−18° C.). The frozen spent sugar beet pulp was thawed in a micro wave oven and milled in a meat grinder to obtain spent sugar beet pulp having an average size of about 5×5×5 mm. The thus obtained spent sugar beet pulp (a) was cooked again at 100° C. for 5 minutes in an excess amount of water. The thus obtained spent sugar beet pulp was loaded with whey protein isolate (BiPro; obtained from Davisco Foods Int.; see Example 3) or with Fava bean protein isolate (HQ Isolate; obtained from Cosun, Dinteloord; see Example 3) using dry protein loading and immobilization using thermal coagulation to provide sugar beet pulp loaded with protein (b). The general recipe for the vegetarian burgers comprising sugar beet pulp (loaded with protein) is given in Table 8.

TABLE 8

| Ingredients | Supplier | Article number | wt. % |
|---|---|---|---|
| SBP (loaded | | | 75.74 |
| with protein) | | | |
| Chicken-egg- | Frisian egg | Chicken Barn egg | 4.95 |
| white protein | | white High Gel | |
| Wheat flour | Albert Heijn | | 4.95 |
| Sugar cane fiber | CFF GmbH | Sanacel SC40 | 0.99 |
| Coconut oil | AAK | CNO 16-001 | 9.90 |
| Hamburger | De Weerd | | 1.29 |
| seasoning | Specerijen BV | | |
| Salt | AkzoNobel | JOZO puur salt | 1.19 |
| | | with jodium fine | |
| Dextrose | Cargill | C*Dex 02043 | 0.99 |
| Total | | | 100.00 |

As a reference, a vegetarian burger based on soy-TVP was produced. The recipe for this vegetarian burger is given in Table 9.

TABLE 9

| Ingredients | Supplier | Article number | wt. % |
|---|---|---|---|
| Soy texturate (TVP) | Dupont Nutrition & | Response 4410 | 22.5 |
| | Biosciences | | |
| Water | | tap water | 53.2 |
| Chicken-egg-white | Frisian egg | Chicken Barn egg white | 3.0 |
| protein | | High Gel | |
| Potato starch (native) | Duynie | Novidon | 1.5 |
| Corn starch | Cargill | Native C*Gel 03401 | 1.5 |
| Psyllium | Brenntag | Psyllium seed husk powder | 1.3 |
| Salt | AkzoNobel | JOZO puur salt with jodium | 1.4 |
| | | fine | |
| Dextrose | Cargill | C*Dex 02043 | 0.5 |
| Lactic acid | Boom b.v | Liquid 88% pure | 0.1 |
| Sugar cane fibre | CFF GmbH&Co KG | Sanacel SC40 | 3.0 |
| Yeast extract-based | DSM | Maxavor Key Roast YEX-H | 1.3 |
| beef flavor | | | |
| Yeast extract based | DSM | Maxavor Key Roast ERX-H | 0.3 |
| flavouring | | | |
| Beef aroma | Givaudan | KK-677-072-7 | 0.2 |
| Hamburger seasoning | De Weerd | | 1.2 |
| | Specerijen BV | | |
| Coconut oil | AAK | CNO 16-001 | 9.0 |
| Total | | | 100.00 |

The vegetarian burgers were produced using the following order of steps:
(i) all ingredients except coconut oil are mixed in a Hobart mixer to obtain a homogeneous dough;
(ii) coconut oil is heated in a micro wave oven to a temperature of about 50° C. and added to the dough obtained in step (i);
(iii) burgers of approximately 110 g are formed from the dough obtained in step (ii) in a burgerpress (Sammic S.L., Ø 10 cm) at about 20° C.;
(iv) the raw burgers obtained in step (iii) are pre-cooked in a steam-oven for 3 minutes at 100° C.;
(v) the pre-cooked burgers obtained in step (iv) are frozen in a freezer (−18° C.); and
(vi) the frozen burgers are thawed in a micro wave oven and baked in a frying pan on an induction hob.

The vegetarian burgers were sensory evaluated by a trained panel of 4 persons and scored on mouthfeel, flavour and juiciness.

The vegetarian burger based on soy TVP had a dry mouthfeel and no juiciness. The vegetarian burger based on sugar beet pulp that was not loaded with protein was less dry and much more juicy than the vegetarian burger based on soy TVP. The vegetarian burgers based on sugar beet pulp loaded with protein were more juicy than the vegetarian burger based on soy TVP but somewhat less juicy than the vegetarian burger based on sugar beet pulp that was not loaded with protein. However, the vegetarian burgers based on sugar beet pulp loaded with protein had a better bite than the vegetarian burger based on sugar beet pulp that was not loaded with protein.

In none of the vegetarian burgers sand was noticed. The vegetarian burgers with fava bean protein isolate had a somewhat better flavour than the vegetarian burgers with whey protein. Both vegetarian burgers did not have a typical sugar beet taste.

### Example 9: Production Sugar Beet Pulp with Increased Water Holding Capacity

A sugar beet pulp with increased water holding capacity was produced as follows. Spent sugar beet pulp in the form of cossettes with a size of approximately 24×3.4×2.1 mm, i.e. fresh sugar beet cossettes that have been subjected to sucrose extraction at a temperature of between 65 and 75° C. for between 30 and 180 minutes without the use of any chemicals, were directly obtained from the diffusion tower and washed with water to remove any residual stones and sand. Foreign matter was rejected from the spent sugar beet cossettes via a metal detector and an optical sorting process before the product was subjected to a blanching step at 95° C. for 20 minutes. After the blanching step, the spent sugar beet cossettes were cooled to a temperature of about 5° C. and were frozen to −19° C. using Individual Quick Freezing technology (IQF). As a result of the processing, the cossettes were broken into smaller particles. The frozen spent sugar beet cossettes were packaged and stored under cold conditions (−18° C.). The frozen spent sugar beet cossettes had a dry matter content of 5.7 wt %. No additives other than water were applied during the process.

The frozen spent sugar beet cossettes, having a dry matter content of 5.7 wt %, were thawed. The water holding capacity of the thawed spent sugar beet cossettes (′sugar beet cossettes A′) was determined using the analytical protocol as defined hereinbefore and was 21.9 g water/g dry matter. The average particle size of the ‘sugar beet cossettes A’ in fully hydrated form was about 10.5×3.4×2.1 mm.

In a first experiment, the particle size of part of the ‘sugar beet cossettes A’ was first reduced by cutting with a knife and further reduced using a Braun 4191 Blender to produce ‘sugar beet particles B’. The water holding capacity of the ‘sugar beet particles B’ with the reduced particle size was determined using the analytical protocol as defined hereinbefore and was higher than 22 g water/g dry matter. The ‘sugar beet particles B’ had a neutral colour. The resulting median particle size of the ‘sugar beet particles B’ in fully hydrated form was about 1 mm, as measured using wet sieving (see analytical protocol defined supra).

In a second experiment, the particle size of part of the ‘sugar beet cossettes A’ was first reduced by cutting with a knife and further reduced using a wolf mill (Kenwood Pro 2000 Excel) to produce ‘sugar beet particles C’. The water holding capacity of the ‘sugar beet particles C’ with the reduced particle size was determined using the analytical protocol as defined hereinbefore and was higher than 22 g water/g dry matter. The ‘sugar beet particles C’ had a neutral colour. The resulting median particle size of the ‘sugar beet particles C’ in fully hydrated form was about 1.4 mm, as measured using wet sieving (see analytical protocol defined supra).

In a third experiment, the particle size of another part of the ‘sugar beet cossettes A’ was reduced by cutting with a knife, followed by using a Braun 4191 Blender, mixing the product obtained from the blender with water in a weight ratio of 1:1 and using a Silverson Model L5 series high shear laboratory mixer to produce ‘sugar beet particles D’. The median particle diameter D50 of the ‘sugar beet particles D’ in fully hydrated from was 443 μm, with a D90 value of 1130 μm and a D10 value of 126 μm, as measured using liquid dispersion laser diffraction (see analytical protocol defined supra). Due to the mixing with water in a 1:1 weight ratio, the ‘sugar beet particles D’ were fully hydrated to their water holding capacity and were present in an excess of water. The sample had an overall dry matter content of 2.85 wt. %.

The repeated water desorption-absorption power of ‘sugar beet particles A’, having a dry matter content of 5.7 wt. % (16.5 g water/g dry matter, i.e. not fully soaked to its potential) and a water holding capacity of 21.9 g water/g dry matter, was determined in accordance with the analytical protocol defined supra. After 1 minute pressing, 444 gram of ‘sugar beet particles A’ released 234 gram press juice. After 4 times of pressing and 4 times of rehydration, the rehydrated ‘sugar beet particles A’ had a weight of 486 gram. So, after the last 1 minute of rehydration, the ‘sugar beet particles A’ contained 19.2 g water/g dry matter, which is close to the water holding capacity (measured after 40 minutes of soaking) of the original ‘sugar beet particles A’ before pressing.

### Example 10: Bakery Products

A yeasted bread was produced using the ‘sugar beet particles C’ produced in Example 9 using the recipe indicated in Table 10.

TABLE 10
recipe for yeasted bread

| Ingredients | supplier | weight [g] | wt. % |
|---|---|---|---|
| Warm water | | 180 | 17.95 |
| Sugar beet particles C | Example 9 | 250 | 24.92 |
| Bread flour (patentbloem) | Albert Heijn | 525 | 52.34 |
| Olive oil (traditional) | Albert Heijn | 20 | 1.99 |
| Salt | | 10 | 1.00 |
| Sugar | | 5 | 0.50 |
| Yeast, dried (Yeast Levure) | Dr Oetker | 8 | 0.80 |
| Flour treatment agent | Robert | 5 | 0.50 |
| Total | | 1003 | 100.00 |

The yeasted bread was produced by combining water (30° C.) and the yeast. After 10 minutes, the remaining ingredients were added and kneaded for 10 minutes at speed 2 in a Hobart mixer. The dough was then allowed to rise for 45 minutes at 35° C. and 85% humidity. The dough was shaped into bread form and allowed to rise again for 50 minutes. Subsequently, steam injection was applied and the bread was baked in an oven for 40 minutes at 200° C. (CIC 220° C. overhead, 230° C. floor).

A brioche bread/bun was produced using the ‘sugar beet particles C’ produced in Example 9 using the recipe indicated in Table 11.

TABLE 11
recipe for brioche bread/bun

| Ingredients | supplier | weight [g] | wt. % |
|---|---|---|---|
| Full fat milk | De Zaanse Hoeve | 100 | 8.05 |
| Sugar beet particles C | Example 9 | 200 | 16.10 |
| Bread flour (patentbloem) | Albert Heijn | 520 | 41.87 |
| Whole eggs (5) | | 220 | 17.71 |
| Salt | | 10 | 0.81 |
| Sugar | | 30 | 2.42 |
| Salted butter, soft (roomboter) | De Zaanse Hoeve | 150 | 12.08 |
| Yeast, dried (Yeast Levure) | Dr Oetker | 7 | 0.56 |
| Sesame seed, black | Albert Heijn | 5 | 0.40 |
| Total | | 1242 | 100.00 |

The brioche bread/bun was produced by mixing eggs, yeast, butter and milk. After 30 minutes standing at 30° C., flour, sugar, ‘sugar beet particles C’ and salt were added and the resulting mixture was mixed until a smooth dough was obtained. After 30 minutes rise at 30° C., the dough was stretched and folded. After stretching and folding, the dough was allowed to rise for another 30 minutes. The dough was shaped into 8 pieces. The dough was proofed a second time for 60 minutes at 30° C. on a greaseproof paper covered with foil. A mixture of whole egg and milk was brushed over the shaped dough pieces and sesame seed was subsequently sprinkled across the top. The shaped dough pieces were baked for 25 minutes at 200° C. in an oven. The resulting brioche breads were left to cool on a wire rack.

A pizza crust was produced using the ‘sugar beet particles C’ produced in Example 9 using the recipe indicated in Table 12.

TABLE 12
recipe for pizza crust

| Ingredients | supplier | weight [g] | wt. % |
|---|---|---|---|
| Sugar beet particles C | Example 9 | 150 | 41.11 |
| Almond flour | Smaakt | 75 | 20.55 |
| Whole eggs (2) | | 95 | 26.03 |
| Parmesan cheese, grated | Albert Heijn | 44.9 | 12.31 |
| (Parmigiano Reggiano) | | | |
| Total | | 364.9 | 100.00 |

The pizza crust was produced as follows. An oven was preheated at 250° C. The ‘sugar beet particles C’, almond flour and parmesan cheese were mixed. Subsequently, the eggs were added and mixing was continued. Parchment paper was lined on a baking tray. The parchment paper was greased with some oil. The dough mixture was applied onto the paper with a thickness of about 0.5 cm. The dough was baked in the oven during 15 minutes until a golden brown pizza crust was obtained. The pizza crust was covered with tomato sauce, mozzarella, mushrooms and some parmesan cheese and was baked again in the oven for 15 minutes.

The pizza was eaten. The crust was crispy and had a nice brown colour. A slice could be eaten from the hand. No sugar beet flavour was observed.

As indicated hereinbefore the ‘sugar beet particles C’ had a dry matter content of 5.7 wt. %. This corresponds to 16.5 g water per gram of dry matter. The water holding capacity of the ‘sugar beet particles C’ is, however, much higher. Hence, the ‘sugar beet particles C’ absorb and hold water in the bakery products. The ‘sugar beet particles C’ also add fiber to the bakery products.

Banketbakkersspijs/marzipan was produced using the ‘sugar beet particles B’ produced in Example 9 using the recipe indicated in Table 13. As compared with conventional banketbakkersspijs/marzipan, almond flour has been completely replaced with ‘sugar beet particles B’. The ingredients were mixed with a Braun 4191 Blender.

TABLE 13
recipe for banketbakkersspijs / marzipan

| Ingredients | supplier | weight [g] | wt. % |
|---|---|---|---|
| Sugar beet particles B | Example 9 | 250 | 45.5 |
| Sugar | | 250 | 45.5 |
| Whole egg (1) | | 48 | 8.7 |
| Zest of half a lemon | | 1.5 | 0.3 |
| Total | | 549.5 | 100.00 |

The banketbakkersspijs/marzipan was put in a piping bag. Two slabs of puff pastry were filled with the banketbakkersspijs/marzipan. The product was baked at 180° C. in the oven for 25 minutes. The product had a neutral taste. The texture was close to that of the conventional product based on almond flour.

### Example 11: Dairy Products

A skimmed yoghurt according to the invention (‘inv.’) was produced using the ‘sugar beet particles D’ produced in Example 9 using the recipe indicated in Table 14. As a reference, a skimmed yoghurt and full fat yoghurt without spent sugar beet particles were produced (‘ref.’).

TABLE 14
recipe for yoghurt

| | | Skimmed | | Full fat | | Skimmed | |
|---|---|---|---|---|---|---|---|
| | | yoghurt (ref.) | | yoghurt (ref.) | | yoghurt (inv.) | |
| Ingredients | Supplier | wt. [g] | wt. % | wt. [g] | wt. % | wt. [g] | wt. % |
| Sugar beet | Example 9 | | | | | 5.25 | 1.75 |
| particles D | | | | | | | |
| Skim milk | Friesland | 291.00 | 97.00 | | | 285.75 | 95.25 |
| (UHT magere | Campina | | | | | | |
| melk) | | | | | | | |
| Full fat milk | Friesland | | | 291.00 | 97.00 | | |
| (UHT volle | Campina | | | | | | |
| melk) | | | | | | | |
| Skimmed milk | NedGold | 9.00 | 3.00 | 9.00 | 3.00 | 9.00 | 3.00 |
| powder | | | | | | | |
| Lactic acid | Chr. | 0.2 | | 0.2 | | 0.2 | |
| bacteria | Hansen | U/liter | | U/liter | | U/liter | |
| culture | | | | | | | |
| CLASSIC | | | | | | | |

| | | | | | | |
|---|---|---|---|---|---|---|
| Total | 300.00 | 100 | 300.00 | 100 | 300.00 | 100 |

Both the reference yoghurts were prepared using the following steps (on lab scale):
Add the skimmed milk powder to the milk (either skim or full fat milk) and solubilize/hydrate for 30 minutes at room temperature while stirring;
Apply high shear mixing at 8000 rpm for 2 minutes using a Silverson Model L5 series high shear laboratory mixer;
Pasteurize the mixture for 1 minute at 85° C. in a HotmixPRO Combi;
Cool the mixture to fermentation temperature (40° C.) in a HotmixPRO Combi;
Add the lactic acid bacteria culture and ferment 14 hrs at 40° C. in a Moulinex Yoghurteo YG231;
Stir, cool down to <7° C. and store refrigerated.

The yoghurt according to the invention was prepared using the procedure described supra wherein in a first step ‘sugar beet particles D’ were added to the skim milk and the resulting mixture was stirred. The yoghurts were evaluated by a sensory panel (see Example 15).

### Example 12: Sauces

A reduced fat plant-based mayonnaise according to the invention (‘inv.’) was produced using the ‘sugar beet particles D’ produced in Example 9 using the recipe indicated in Table 15. As a reference, a full fat mayonnaise without sugar beet particles was produced (‘ref.’).

TABLE 15
recipe for mayonnaise

| | | Full fat (70%) | | Reduced fat (49%) | |
|---|---|---|---|---|---|
| | | mayonnaise (ref.) | | mayonnaise (inv.) | |
| Ingredients | Supplier | wt. [g] | wt. % | wt. [g] | wt. % |
| Sugar beet particles D | Example 9 | | | 63.00 | 10.50 |
| Water | | 90.50 | 15.08 | 153.50 | 25.58 |
| Sunflower oil | | 420.00 | 70.00 | 294.0 | 49.00 |
| Salt | | 6.00 | 1.00 | 6.00 | 1.00 |
| Sugar fine | | 15.00 | 2.50 | 15.00 | 2.50 |
| Vinegar 2.17 Bx (6%) | Natuurazijn wit | 50.00 | 8.33 | 50.00 | 8.33 |
| | van Gwoon | | | | |
| Lactic acid | Boom b.v. | 0.30 | 0.05 | 0.30 | 0.05 |
| (concentrated, 88%) | | | | | |
| Lemon juice | | 4.80 | 0.80 | 4.80 | 0.80 |
| Dijon mustard | Kühne | 1.80 | 0.30 | 1.80 | 0.30 |
| Potassium sorbate | | 0.60 | 0.10 | 0.60 | 0.10 |
| EDTA | | 0.05 | 0.01 | 0.05 | 0.01 |
| Vinegar 23% | Burg Azijn b.v. | 2.00 | 0.33 | 2.00 | 0.33 |
| Fava protein isolate, | Cosun Protein | 9.00 | 1.50 | 9.00 | 1.50 |
| Tendra ® | | | | | |

| | | | | |
|---|---|---|---|---|
| Total | 600.05 | 100.00 | 600.05 | 100.00 |

The reduced fat mayonnaise according to the invention was produced as follows (lab scale). In a first step water and ‘sugar beet particles D’ were blended (1:1 weight ratio) to provide a smooth puree. To this puree, the remaining water, the two vinegars, the lactic acid and the lemon juice were added and the resulting mixture was stirred. Subsequently, the fava protein isolate, EDTA, sugar and potassium sorbate were added and the mixture was stirred for 10 minutes. Then, the Dijon mustard was added and the mixture was subjected to high shear mixing at 10000 rpm for 2 minutes using a Silverson Model L5 series high shear laboratory mixer. Next, the sunflower oil was slowly added and the product while mixing at 8000 rpm using the Silverson. The mayonnaise were evaluated by a sensory panel (see Example 15).

### Example 13: Meat Substitutes and Hybrid Meat Products

A seaweed nugget according to the invention (‘inv.’) was produced using the ‘sugar beet particles C’ produced in Example 9 using the recipe indicated in Table 16. The seaweed nugget was evaluated by a sensory panel. Positive reactions were obtained concerning juiciness and bite.

TABLE 16
recipe for seaweed nugget

| | | weight | |
|---|---|---|---|
| Ingredients | Supplier | [g] | wt. % |
| Sugar beet particles C | Example 9 | 80 | 43.70 |
| Water chestnut | | 20 | 10.92 |
| Ginger | | 1.5 | 0.82 |
| Onion | | 15 | 8.19 |
| Royal kombu flakes | Dutch Seaweed Group | 1.8 | 0.98 |
| Wakame flakes | Dutch Seaweed Group | 2 | 1.09 |
| Water | | 30 | 16.39 |
| Potato flakes, 833404 | Aviko | 7 | 3.82 |
| Lemon juice | | 4 | 2.18 |
| Salt | | 0.4 | 0.22 |
| Flour | | 8 | 4.37 |
| Corn starch C☆Tex ® 06201 | Cargill | 4 | 2.18 |
| Wheat fiber wf400 | J. Rettenmaier & | 1.35 | 0.74 |
| (VITACEL ®) | Söhne GmbH | | |
| Dried royal kombu | Dutch Seaweed Group | 1.2 | 0.66 |
| Dried wakeme | Dutch Seaweed Group | 1.5 | 0.82 |
| Black pepper | | 0.05 | 0.03 |
| Flavours, herbs and spices | | 4.3 | 2.34 |
| Sunflower oil | | 1 | 0.55 |

| | | |
|---|---|---|
| Total | 183.08 | 100.00 |

A falafel burger according to the invention (‘inv.’) was produced using the ‘sugar beet particles C’ produced in Example 9 using the recipe indicated in Table 17. The falafel burger was evaluated by a sensory panel. Positive reactions were obtained concerning juiciness, texture and bite.

TABLE 17
recipe for falafel burger

| Ingredients | supplier | weight [g] | wt. % |
|---|---|---|---|
| Sugar beet particles C | Example 9 | 41 | 28.89 |
| Chick peas | | 34 | 23.96 |
| Chickpea flour | | 5.1 | 3.59 |
| Onion | | 10 | 7.05 |
| Methyl cellulose a4m | | 0.2 | 0.14 |
| Water | | 30 | 21.14 |
| Potato flakes, 833404 | Aviko | 8 | 5.64 |
| Salt | | 1.5 | 1.06 |
| Corn starch C☆Tex ® 06201 | Cargill | 4 | 2.82 |
| Flavours, herbs and spices | | 6.6 | 4.65 |
| Sunflower oil | | 1.5 | 1.06 |

| | | |
|---|---|---|
| Total | 141.9 | 100.00 |

A ‘beetball’ according to the invention (‘inv.’) was produced using the ‘sugar beet particles C’ produced in Example 9 using the recipe indicated in Table 18. The ‘beetball’ was evaluated by a sensory panel. Positive reactions were obtained concerning mouthfeel, moisture and juiciness.

TABLE 18
recipe for ‘beetball’

| Ingredients | supplier | weight [g] | wt. % |
|---|---|---|---|
| Sugar beet particles C | Example 9 | 40 | 46.80 |
| Apple | | 5 | 5.85 |
| Vegan binder (15253-0) | Multiflour & | 4.4 | 5.15 |
| | MPF Benelux | | |
| Onion | | 10 | 11.70 |
| Oyster mushrooms | | 5 | 5.85 |
| Water | | 7 | 8.19 |
| Potato flakes, 833404 | Aviko | 3 | 3.51 |
| Salt | | 0.9 | 1.05 |
| Inulin (Frutafit ® HD/IQ) | Sensus | 1.5 | 1.76 |
| Corn starch C☆Tex ® 06201 | Cargill | 5 | 5.85 |
| Flavours, herbs and spices | | 1.77 | 2.08 |
| Coconut oil | | 1.9 | 2.22 |

| | | |
|---|---|---|
| Total | 85.47 | 100.00 |

Vegan Italian seitan sausages according to the invention (‘inv.’) were produced using the ‘sugar beet particles C’ produced in Example 9 using the recipe indicated in Table 19.

TABLE 19
recipe for vegan Italian seitan sausages

| Ingredients | weight [g] | wt. % |
|---|---|---|
| Sugar beet particles C (Example 9) | 250 | 25.21 |
| Vital wheat gluten | 300 | 30.25 |
| Dried rosemary | 0.8 | 0.08 |
| Onion, chopped | 75 | 7.56 |
| Nutritional yeast | 8.63 | 0.87 |
| Vegetable broth | 180 | 18.15 |
| Salt | 3.55 | 0.36 |
| Garlic, minced | 15 | 1.51 |
| Brown sugar | 3.25 | 0.33 |
| Sun-dried tomatoes, finely chopped (on oil) | 20 | 2.02 |
| Olive oil | 10 | 1.01 |
| Tomato paste | 60 | 6.05 |
| White miso | 60 | 6.05 |
| Dried basil | 1.4 | 0.14 |
| Fennel seeds | 2.71 | 0.27 |
| Liquid smoke, smoked paprika powder | 1.52 | 0.15 |
| Total | 991.86 | 100.00 |

The vegan Italian seitan sausages were produced as follows. The onions and garlic were sautéed in the olive oil for 5 minutes. The vegetable broth, tomato paste and white miso were mixed until a smooth mixture was obtained. Subsequently, the sun dried tomatoes, nutritional yeast, dried basil, brown sugar, fennel seeds, dried rosemary, salt, liquid smoke, and sautéed onion-garlic mix were added and stirred. Then, ‘sugar beet particles C’ and wheat gluten were added to make a dough. The dough was cut into 6 equal pieces and shaped into sausage-like shapes. The sausages were fully covered in aluminium foil and steamed for 40 minutes. The steamed sausages were cooled in a fridge.

The vegan Italian seitan sausages were evaluated by a sensory panel. The Italian flavoured sausages firmed up well after steaming and cooling down. The sausages could easily be cut into slices and baked in a pan with oil. The ‘sugar beet particles C’ in the sausages look like fat particles which are normally seen in sausage made from animal meat. The flavour of the sausages was good.

Hybrid Swedish meatballs according to the invention (‘inv.’) were produced using the ‘sugar beet particles C’ produced in Example 9 using the recipe indicated in Table 20.

TABLE 20
recipe for hybrid Swedish meatballs

| Ingredients | weight [g] | wt. % |
|---|---|---|
| Sugar beet particles C (Example 9) | 300 | 38.28 |
| Minced beef | 300 | 38.28 |
| Marne, French mustard, mild | 4.5 | 0.57 |
| Onion, chopped | 40 | 5.10 |
| Egg | 100.00 | 12.76 |
| Burger spices (paprika powder, pepper, aroma, | 5.28 | 0.67 |
| coriander, onion powder and rosemary powder) | | |
| Salt | 11.82 | 1.51 |
| Breadcrumbs | 22.07 | 2.82 |
| Total | 783.67 | 100.00 |

The hybrid Swedish meatballs were evaluated by a sensory panel. The balls had a nice brown colour. The balls were tasty, moist and juicy. No typical sugar beet flavour was observed.

### Example 14: Fruit-Like Product

A fruit-like product according to the invention (‘inv.’) was produced using the ‘sugar beet particles A’ produced in Example 9, sugar and sour cherry juice concentrate, clarified R=65, frozen, 1509100 (SVZ International B.V.). ‘Sugar beet particles B’ and cherry juice concentrate were mixed in a 1:1 weight ratio and part of the water was evaporated to a level of 30° Bx in a Rotovapor R-107. Sugar was added in an amount to reach 60° Bx. The product was mixed and stored cool (4° C.) for a day. After 24 hours, most of the sugar was dissolved. Most of the cherry juice concentrate and sugar were absorbed or infused in the ‘sugar beet particles A’.

About 100 g of the fruit-like product was mixed with 1 liter vanilla ice cream (Jumbo Supermarkt). The product was stored overnight in a freezer and was subsequently evaluated by a sensory panel (see Example 15).

### Example 15: Sensory Analysis

Products were subjected to sensory analysis by a trained taste panel consisting of 8 panelists. Sensory analysis started with visually observing and tasting to find the relevant attributes to be assessed. As a subsequent step, the attributes were discussed to find a characteristic definition. The actual scoring of the attributes was performed without discussion.

The scores that were used are as follows:

TABLE 21

| −2 | −1 | 0 | 1 | 2 |
|---|---|---|---|---|
| Very bad | Bad | Average | Good | Very good |

The scores from the 8 panelists were added for every individual attribute. The scores for the yoghurts described in Example 11, for the mayonnaises described in Example 12 and for the ice cream with fruit-like product described in Example 14 are presented in Tables 22, 23 and 24, respectively.

TABLE 22
scores sensory panel for yoghurt

| | Skimmed yoghurt | Full fat yoghurt | Skimmed yoghurt |
|---|---|---|---|
| Attribute | (ref.) | (ref.) | (inv.) |
| Free water⁽*⁾ | −6 | 6 | −3 |
| Smoothness | −3 | 4 | −1 |
| Colour | −3 | 3 | −1 |
| Thickness | −4 | 5 | 2 |
| Taste intensity | 0 | 0 | 1 |
| Smell | 0 | −1 | 0 |

⁽*⁾Free water is water that is separated from the yoghurt due to syneresis

Low fat yoghurt has a sour palette and a texture of low viscosity. Full fat yoghurt is appreciated for its creamy and viscous texture. It was concluded that addition of the ‘sugar beet particles D’ to skimmed (low-fat) yoghurt shifts the mouthfeel towards that of full fat yoghurt on the aspects of free water, smoothness, colour and thickness. Hence, the sugar beet pulp according to the invention can be used as fat replacer and texturizer in dairy products.

TABLE 23
scores sensory panel for mayonnaise

| | Full fat (70%) | Reduced fat (49%) |
|---|---|---|
| Attribute | mayonnaise (ref.) | mayonnaise (inv.) |
| Thickness/jelly density | −3 | −4 |
| Lingering/long lasting | 0 | −2 |
| Fattiness | −2 | −2 |

The mayonnaise with reduced fat content comes to almost comparable ratings on thickness/jelly density, lingering/long lasting and fattiness. It was concluded that the sugar beet pulp according to the invention can be used as fat replacer and texturizer in sauces.

TABLE 24
scores sensory panel for ice cream with fruit-like product

| Attribute | Ice cream with fruit product (inv.) |
|---|---|
| Chunky bite | 11 |
| Colour | 5 |
| Firmness | 9 |
| Flavour intensity | 6 |

The fruit-like product was not frozen like ice. Without wishing to be bound by any theory, it is believed that the high Bx-value lowered the freezing point of the fruit-like product. The panel members were positively surprised by the fruity and texture aspects of this fruit-like product.

1. Sugar beet pulp which is configured to:
(a) absorbing an amount of water that is at least 20 times the dry weight of the sugar beet pulp;
(b) holding an amount of water that is at least 20 times the dry weight of the sugar beet pulp; or
(c) a combination of (a) and (b).

2. Sugar beet pulp according to claim 1, configured to:
(a) absorbing an amount of water that is at least 25 times the dry weight of the sugar beet pulp;
(b) holding an amount of water that is at least 25 times the dry weight of the sugar beet pulp; or
(c) a combination of (a) and (b).

3. Sugar beet pulp according to claim 1, wherein the sugar beet pulp is processed spent sugar beet pulp.

4. Sugar beet pulp according to claim 1, characterized by one or more of the following:
the sugar beet pulp comprises less than 6 wt. % of mono- and disaccharides, based on the dry weight of the sugar beet pulp;
the sugar beet pulp comprises less than 8 wt. % of HCl-unsolvable ash, based on the dry weight of the sugar beet pulp, as measured in accordance with NEN-ISO 5985:2003;
the amount of water is between 3 and 97 wt. %, based on the weight of the sugar beet pulp;
the sugar beet pulp comprises cellulose and hemicellulose;
the sugar beet pulp is food grade; and
the average firmness of the sugar beet pulp at a temperature of 20° C. is between 100 and 900 g, as measured with a texture analyzer (Stable Micro Systems Ltd, TA-XT Plus) equipped with a 5 kg load cell, a slotted base plate and a standard knife/blade set (HDP/BS) consisting of a reversible knife edge and a Warner Bratzler blade, in accordance with the analytical procedure defined in the experimental section.

5. Sugar beet pulp according to claim 1, having a water content of between 60 and 97 wt. %, based on the weight of the sugar beet pulp.

6. Sugar beet pulp according to claim 1, comprising at least 20 wt. % pectin, based on dry matter of the sugar beet pulp.

7. Sugar beet pulp according to claim 1, having in fully hydrated form a median particle diameter of between 500 μm and 10 mm, as determined using wet sieving in accordance with the analytical procedure defined in the experimental section.

8. Sugar beet pulp according to claim 1, having in fully hydrated form a median particle diameter (D50) of between 100 and 850 μm, as determined using liquid dispersion laser diffraction.

9. Method for improving the water absorption capacity and/or water holding capacity of sugar beet pulp, comprising the steps of:
(a) providing sugar beet material;
(b) optionally extracting mono- and disaccharides from the sugar beet material provided in step (a) at a temperature below 75° C. to provide spent sugar beet pulp;
(c) subjecting the sugar beet material provided in step (a) or the spent sugar beet pulp provided in step (b) to heating at a temperature of at least 85° C. to obtain sugar beet pulp with an improved water absorption capacity and/or water holding capacity;
(d) optionally removing mono- and disaccharides from the sugar beet pulp obtained in step (c).

10. Method according to claim 9, further comprising freezing and thawing.

11. Method according to claim 10, comprising the steps of:
(aa) providing sugar beet material;
(bb) extracting mono- and disaccharides from the sugar beet material provided in step (aa) at a temperature below 75° C. to provide spent sugar beet pulp;
(cc) subjecting the spent sugar beet pulp obtained in step (bb) to heating at a temperature of at least 90° C. for at least 10 minutes;
(dd) freezing the sugar beet pulp obtained in step (cc);
(ee) optionally reducing the particle size of the sugar beet pulp obtained in step (dd);
(ff) thawing the sugar beet pulp obtained in step (dd) or (ee), to obtain sugar beet pulp with an improved water absorption capacity and/or water holding capacity; and
(gg) optionally reducing the particle size of the sugar beet pulp obtained in step (ff).

12. Method according to claim 9, wherein the moisture content of the sugar beet material and sugar beet pulp is higher than 60 wt. %, based on the weight of the sugar beet material or the sugar beet pulp, throughout the process.

13. Method according to claim 9, not comprising the step of:
(i) organic solvent treatment or extraction;
(ii) treatment with sulphited water;
(iii) potassium oxalate treatment or extraction;
(iv) sulphurous acid treatment or extraction;
(v) hydrogen peroxide treatment;
(vi) acid treatment;
(vii) alkali treatment; or
(viii) a combination of two or more of (i)-(vii).

14. Method according to claim 9, not comprising a step wherein one or more chemicals are added.

15.-23. (canceled)

24. Sugar beet pulp according to claim 1, configured to:
(a) absorbing an amount of water that is at least 30 times the dry weight of the sugar beet pulp;
(b) holding an amount of water that is at least 30 times the dry weight of the sugar beet pulp; or
(c) a combination of (a) and (b).

25. Sugar beet pulp according to claim 1, characterized by a water activity (AW) between 0.10 and 0.80 as measured at 25° C. with a Lab Master-aw neo water activity measurement device (Novasina AG).

26. Sugar beet pulp according to claim 1, comprising one or more, of the following microbial requirements:
total thermophilic bacteria count: ≤1000 CFU/(g of the sugar beet pulp), as determined in accordance with ISO 4833-1:2013;
total thermophilic spores count: ≤25 CFU/(g of the sugar beet pulp), as determined in accordance with ICUMSA GS2_{/3}-49 (1998);
total mesophilic bacteria count: ≤150 CFU/(g of the sugar beet pulp), as determined in accordance with ISO 4833-1:2013;
total mesophilic spores count: ≤150 CFU/(g of the sugar beet pulp), as determined in accordance with NEN 6813:2014 nl;
total moulds count: ≤1 CFU/(g of the sugar beet pulp), as determined in accordance with ISO 21527-1:2008; and
total yeast count: ≤1 CFU/(g of the sugar beet pulp), as determined in accordance with ISO 21527-1:2008.

27. Sugar beet pulp according to claim 1, comprising one or more, of the following microbial requirements:
Salmonella spp: non-detectable number of CFU/(25 g of the sugar beet pulp), as determined in accordance with ISO 6579-1:2017;
Enterobacteriaceae: non-detectable number of CFU/(25 g of the sugar beet pulp), as determined in accordance with ISO 21528-1:2017;
Staphylococcus aureus: non-detectable number of CFU/(g of the sugar beet pulp), as determined in accordance with ISO-6888-3:2003;
Listeria spp: non-detectable number of CFU/(25 g of the sugar beet pulp), as determined in accordance with NEN-EN-ISO 11290-1/2:2014;
Listeria monocytogenes: non-detectable number of CFU/(25 g of the sugar beet pulp), as determined in accordance with NEN-EN-ISO 11290-1/2:2014; and
B. cereus: ≤100 CFU/(g of the sugar beet pulp), preferably ≤50 CFU/(g of the sugar beet pulp), as determined in accordance with ISO 7932:2004.

28. The method according to claim 9, further comprising a drying step, to obtain a product having a water activity (AW) between 0.10 and 0.80 as measured at 25° C. with a Lab Master-aw neo water activity measurement device (Novasina AG).

29. The method according to claim 9, not comprising a step of high-shear mixing.

30. The method according to claim 9, wherein step (c) comprises subjecting the sugar beet material provided in step (a) or the spent sugar beet pulp provided in step (b) to heating at a temperature of at least 90° C. for a period of at least 1 minute.
